(19) United States
(12) Patent Application Publication
(10) Pub. No.: US 2026/0142757 A1
(43) Pub. Date: May 21, 2026

(54) DATA-AIDED CYCLIC PREFIX-ORTHOGONAL FREQUENCY DIVISION MULTIPLEXING COMMUNICATIONS

(71) Applicant: Samsung Electronics Co., Ltd., Suwon-si (KR)

(72) Inventors: Caleb K. Lo, San Jose, CA (US); Joonyoung Cho, Portland, OR (US); Fabrizio Carpi, Dallas, TX (US); Jianzhong Zhang, Dallas, TX (US)

(21) Appl. No.: 19/364,890

(22) Filed: Oct. 21, 2025

Related U.S. Application Data
(60) Provisional application No. 63/722,733, filed on Nov. 20, 2024.

(51) Int. Cl. H04L 5/00; H04L 41/16

(52) U.S. Cl. CPC H04L 5/0007; H04L 41/16

(57) ABSTRACT

A method to generate information about data in a data-aided communication system is provided. The data-aided communication system includes a first electronic device and a second electronic device. The first electronic device receives a signal including data transmitted over a band channel from a second electronic device. The first electronic device generates information about the transmitted data using an artificial intelligence model trained to generate information about input bits.

### CROSS-REFERENCE TO RELATED APPLICATION AND CLAIM OF PRIORITY

The present application claims priority under 35 U.S.C. § 119 (e) to U.S. Provisional Patent Application No. 63/722,733 filed on Nov. 20, 2024, which is hereby incorporated by reference in its entirety.

### TECHNICAL FIELD

This disclosure relates generally to wireless networks. More specifically, this disclosure relates to a method and apparatus for data-aided cyclic prefix orthogonal frequency division multiplexing (CP-OFDM) communications.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for data-aided CP-OFDM communications in wireless communication systems.

In one embodiment, a method is provided. The method may include: receiving, by a first electronic device, a signal including data transmitted over a band channel from a second electronic device; and generating, by the first electronic device, information about the transmitted data using an artificial intelligence (AI) model trained to generate information about input bits.

In another embodiment, a first electronic device is provided. The first electronic device may include a memory and a processor operably couple do the memory. The processor may be configured to: receive, from a second electronic device, a signal including data transmitted over a band channel; and generate information about the transmitted data using an AI model trained to generate information about input bits.

In yet another embodiment, a non-transitory computer readable medium embodying a computer program is provided, The computer program may include program code that, when executed by a processor of a first electronic device, causes the first electronic device to: receive, from a second electronic device, a signal including data transmitted over a band channel; and generate information about the transmitted data using an AI model trained to generate information about input bits.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network in accordance with example embodiments of the present disclosure;

FIG. 2 illustrates an example gNB in accordance with example embodiments of the present disclosure;

FIG. 3 illustrates an example UE in accordance with example embodiments of the present disclosure;

FIG. 4 illustrates an example network device in accordance with example embodiments of the present disclosure;

FIG. 5 illustrates an example RS pattern in accordance with example embodiments of the present disclosure;

FIG. 6 illustrates example modulation constellations that can be used to facilitate the RS overhead reduction in accordance with example embodiments of the present disclosure;

FIG. 7 illustrates an example data-aided wireless communication system in accordance with example embodiments of the present disclosure;

FIG. 8 illustrates an example reduced RS overhead in accordance with example embodiments of the present disclosure;

FIG. 9 illustrates an example process of receive operations performed by an Rx architecture to support an NN Rx for data-aided communications in accordance with example embodiments of the present disclosure;

FIGS. 10A-C illustrate an example architecture of an NN Rx for a data-aided communication system in accordance with example embodiments of the present disclosure;

FIG. 11 illustrates an example process of receive operations performed by an Rx architecture for data-aided communications in accordance with example embodiments of the present disclosure;

FIG. 12 illustrates an example process of receive operations performed by an Rx architecture for data-aided communications in accordance with example embodiments of the present disclosure;

FIG. 13 illustrates an example process of receive operations performed by an Rx architecture for data-aided communications in accordance with example embodiments of the present disclosure;

FIG. 14 illustrates an example process of receive operations performed by an Rx architecture for data-aided communications in accordance with example embodiments of the present disclosure;

FIGS. 15 and 16 illustrate example processes of receive operations performed by an Rx architecture for data-aided communications in accordance with example embodiments of the present disclosure;

FIG. 17 illustrates an example process of receive operations performed by an Rx architecture for data-aided communications in accordance with example embodiments of the present disclosure;

FIG. 18 illustrates example DMRS patterns that can be configured for data-aided transmission in accordance with example embodiments of the present disclosure;

FIG. 19 illustrates an example architecture of an Rx architecture for data-aided transmission with an RS in accordance with example embodiments of the present disclosure;

FIG. 20 illustrates an example process of receive operations performed by an Rx architecture for data-aided communications with RSs in accordance with example embodiments of the present disclosure;

FIGS. 21 and 22 illustrate example processes of receive operations performed by an Rx architecture for data-aided communications with RSs on separate channels in accordance with example embodiments of the present disclosure;

FIG. 23 illustrates an example pipeline for training an NN Rx in a data-aided communication system accordance with example embodiments of the present disclosure;

FIG. 24 illustrates an example pipeline for training an NN Rx with channel coding operation in a data-aided communication system in accordance with example embodiments of the present disclosure;

FIG. 25 illustrates an example method for training an NN Rx for data-aided communications in accordance with example embodiments of the present disclosure;

FIG. 26 illustrates an example pipeline for training an NN Rx with channel encoding for data-aided communications in accordance with example embodiments of the present disclosure;

FIG. 27 illustrates an example method for training an NN Rx with channel encoding for data-aided communications in accordance with example embodiments of the present disclosure;

FIG. 28 illustrates an example pipeline for training an NN Rx with other AI/ML blocks in a data-aided communication system in accordance with example embodiments of the present disclosure

FIGS. 29 and 30 illustrate example methods for training an NN Rx with other AI-based components in a data-aided communication system in accordance with example embodiments of the present disclosure

FIG. 31 illustrates an example architecture of an Rx architecture with an NN channel estimator in a data-aided communication system in accordance with example embodiments of the present disclosure

FIG. 32 illustrates an example method for operations at an Rx architecture for data-aided communication with an NN channel estimator in accordance with example embodiments of the present disclosure

FIG. 33 illustrates an example method for operations at an Rx architecture for a data-aided communication system in accordance with example embodiments of the present disclosure

FIG. 34 illustrates an example method for operations at an Rx architecture with per-RB processing for an NN channel estimator in accordance with example embodiments of the present disclosure

FIG. 35 illustrates an example pipeline of training an NN Rx with an NN channel estimator in a data-aided communication system in accordance with example embodiments of the present disclosure

FIG. 36 illustrates an example method for training an NN Rx and an NN channel estimator in a data-aided communication system in accordance with example embodiments of the present disclosure

FIG. 37 illustrates an example flow chart for a method of generating information associated with transmitted data using an NN Rx in accordance with example embodiments of the present disclosure.

### DETAILED DESCRIPTION

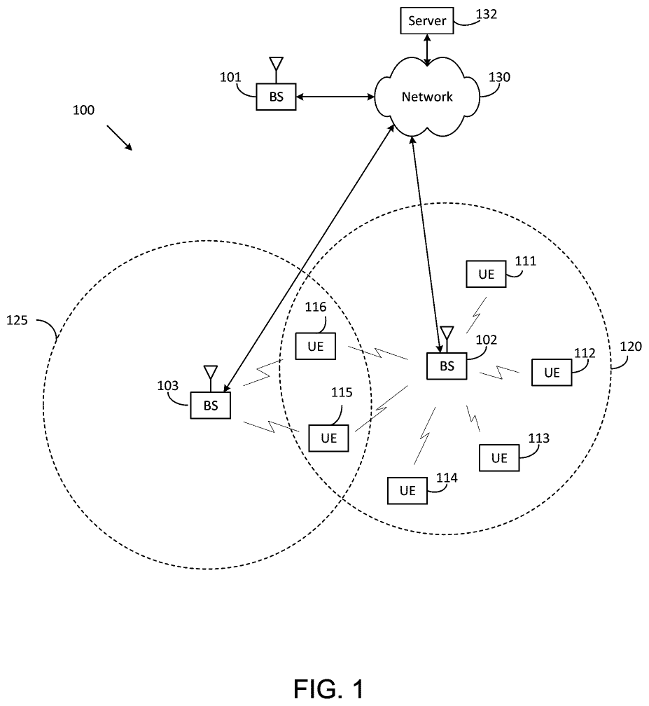

FIGS. 1 through 37, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mm Wave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band.

For example, aspects of the present disclosure may also be applied to deployment of 5G communication systems, 6G or even later releases which may use terahertz (THz) bands.

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

The wireless network 100 may be an artificial intelligence (AI)-based wireless communication system. As such, the at least one network 130 may be operably coupled to an electronic device (e.g., without limitation, a network server) 132 configured to, for example and without limitation, receive data from the gNBs 101-103 and train an AI and/or ML model (hereinafter, also referred to as the AI model) to support data-aided transmissions. The server 132 may represent one or more servers, and each server 132 includes a suitable computing or processing device for training the AI model. Each server 132 could, for example, include one or more processing devices, one or more memories storing instructions and data, and one or more network interfaces to receive the data. The AI model is then trained and deployed to effectively to support data-aided CP-OFDM communications in wireless communication networks 100.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support data-aided transmissions in wireless communication systems. In certain embodiments, one or more of the gNBs 101-103 include circuitry, programing, or a combination thereof, to support data-aided transmissions in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

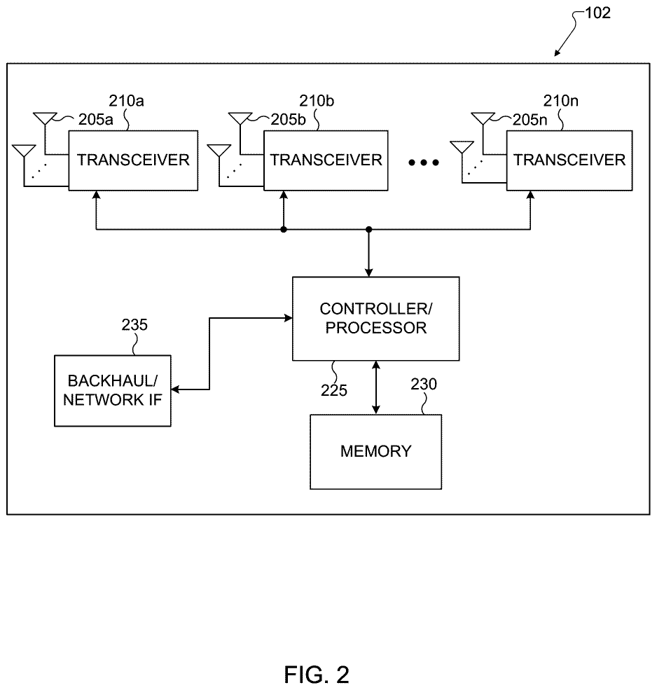

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support data-aided transmissions in wireless communication systems as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

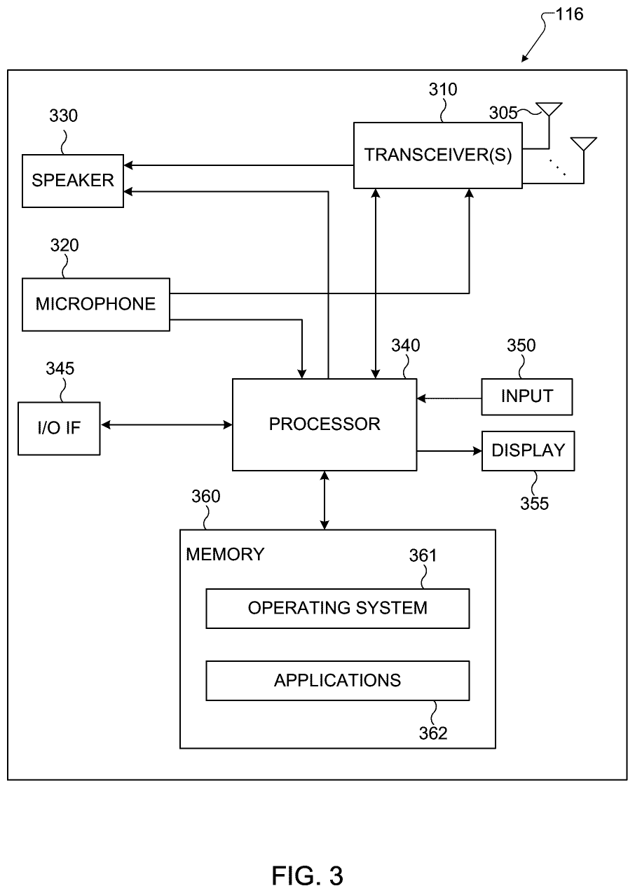

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support data-aided transmissions in wireless communication systems as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUS). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

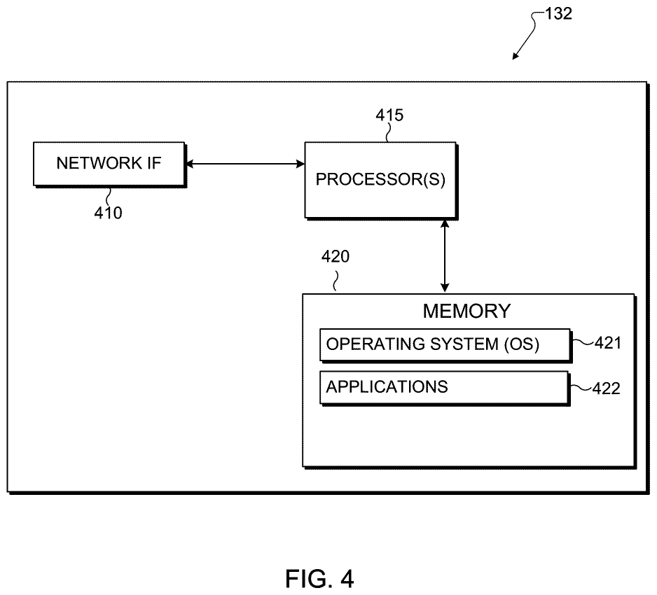

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410 and the UEs 111-116 via the gNBs 101-103.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network as well as a CPU, a GPU or a tensor processing unit (TPU) that provides significant computational resources for training the neural network.

The processor 415 is also capable of executing other processes and programs resident in the memory 420, such as operations that receive and store data. As described in greater detail below, the processor 415 may execute processes to train an AI model to support data-aided transmissions in the wireless communication systems. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for an AI model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). For example, the storage may include data prepared for training of the AI model. The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

The modern wireless systems, such as those described regarding FIGS. 1-4, utilize several types of reference signals (RSs) that have been defined. For example, a channel state information reference signal (CSI-RS) may be used for DL communication between a gNB and a UE, where the UE uses received CSI-RS to measure DL CSI and report those measurements to the gNB. Also, a demodulation reference signal (DMRS) may be used by a receiver (either for DL or UL communications) to estimate CSI to demodulate received data.

A time-frequency mapping function may be applied to RSs such as the CSI-RS and DMRS before they are transmitted, yielding a particular RS pattern. An RS pattern may depend on parameters such as a transmit antenna port, code division multiplexing (CDM) type, and frequency hopping enablement status.

When a resource element (RE) is used to transmit an RS, the transmission overhead may increase as that RE is not used to transmit data. It may be advantageous to reduce—or even eliminate—the overhead of the RS based on the statistics of an underlying randomly-varying wireless channel. For example, if the channel is static, then an RS signaling can be (at least temporarily) disabled, assuming that a properly-designed receiver can still recover transmitted data in the absence of an RS.

5G NR supports flexibility in the selection of an RS pattern. The selection of an RS pattern may be based on the statistics of the underlying randomly-varying wireless channel. For example, the parameter dmrs-AdditionalPosition can be used to increase the number of DMRS in a given slot in high-mobility scenarios. As another example, the parameters periodicityAndOffset-p and periodicityAndOffset-sp can be used to vary the periodicity (and slot offset) of SRS. The details of the algorithm for selecting an RS pattern are typically left to the network.

The present disclosure describes a framework for supporting AI/ML techniques for reducing the overhead of the RS via a data-aided transmission, in which one or more data symbols may be leveraged generate information about the transmitted data and/or the underlying wireless channel.

By using an AI model (e.g., a neural network receiver) trained to implicitly estimate an underlying wireless channel from the one or more data symbols, the embodiments of the present disclosure may facilitate data-aided CP-OFDM communications. The data-aided CP-OFDM communications may be also facilitated by determining one or more explicit channel estimates from the one or more data symbols by a channel estimation (CE) AI model and transmitting the one or more explicit channel estimates as side information from the CE AI model to the AI model. In those instances, the AI model may be then trained to incorporate the side information for demodulating the one or more data symbols. In some embodiments, the AI model may be trained without the one or more explicit channel estimates from the distinct pilot symbols. The data-aided CP-OFDM communications may be also facilitated by utilizing uniform modulation constellations or non-uniform modulation constellations.

Methods for generating transmitted data information and channel estimates based on demodulated data symbols to facilitate data-aided CP-OFDM communications and corresponding detail are provided in this disclosure below.

The following documents and standards descriptions are hereby incorporated by reference into the present disclosure as if fully set forth herein:
[1] 3GPP, TS 38.211, 5G; NR; Physical channels and modulation
[2] 3GPP, TS 38.331, 5G; NR; Radio Resource Control (RRC); Protocol specification
[3] 3GPP, TS 38.321, 5G; NR; Medium Access Control (MAC); Protocol specification.

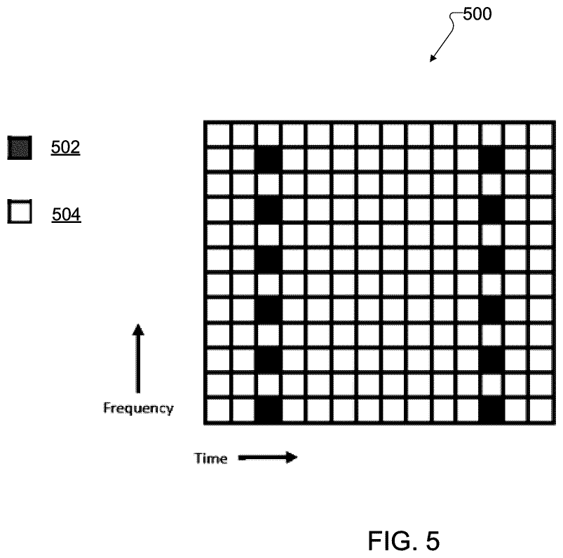

FIG. 5 illustrates an example RS pattern 500 in accordance with example embodiments of the present disclosure. The example RS pattern 500 shown in FIG. 5 is for illustration only, and the RS pattern could have similar or different configuration. However, FIG. 5 does not limit the scope of this disclosure to any particular RS pattern.

In the example RS pattern 500 as shown in in FIG. 5, an RS is placed in the first REs 502 while data is placed in the second REs 504. In this example, 12 out of the 168 REs in this physical resource block (PRB) contain the RS, and thus, the overhead of the RS is about 7%. Tracking of channel variations over time may be facilitated by placing the RS on the third and the twelfth symbols. Also, tracking of channel variations over frequency may be facilitated by placing the RS on every other RE in those two symbols.

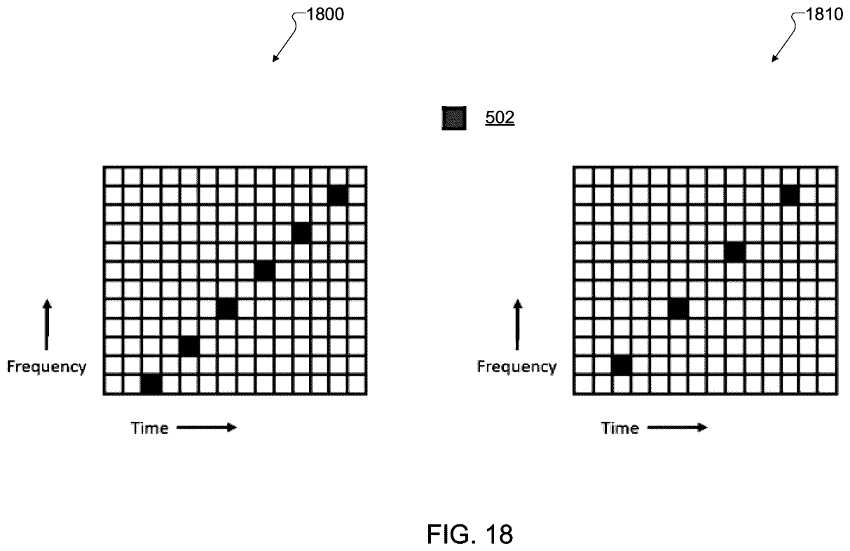

The RS overhead of about 7% in FIG. 5 can be reduced in some situations as illustrated in FIGS. 8 and 18.

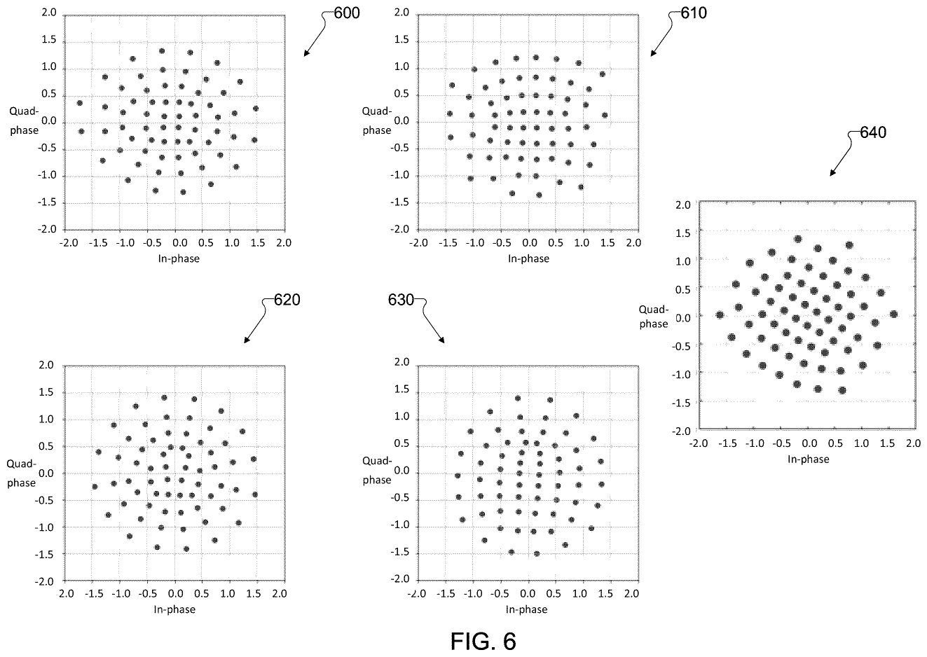

FIG. 6 illustrates example modulation constellations 600, 610, 620, 630, 640 that can be used to facilitate the RS overhead reduction in accordance with example embodiments of the present disclosure. Each of these modulation constellations 600, 610, 620, 630, 640 has been obtained via an AI/ML framework. The example modulation constellations 600, 610, 620, 630, 640 shown in FIG. 6 are for illustration only, and the modulation constellations 600, 610, 620, 630, 640 could have the same or similar configuration. However, FIG. 6 does not limit the scope of this disclosure to any particular modulation constellations.

The example constellations 600, 610, 620, 630, 640 may be more irregular than other modulation constellations such as square 64-QAM, thereby allowing them to be utilized for estimating amplitude and phase impairments. For example, rotating any of these constellations 600, 610, 620, 630, 640 through an arbitrary angle may yield a different constellation, i.e., they have no inherent phase ambiguity. In contrast, rotating a square QAM constellation through 90 degrees yields an identical constellation. Thus, data symbols from the constellations 600, 610, 620, 630, 640 can be used for channel estimation and/or demodulation. Whereas, if RSs are not transmitted and if the channel applies a phase rotation of 90 degrees, data symbols from a square QAM constellation may not be demodulated.

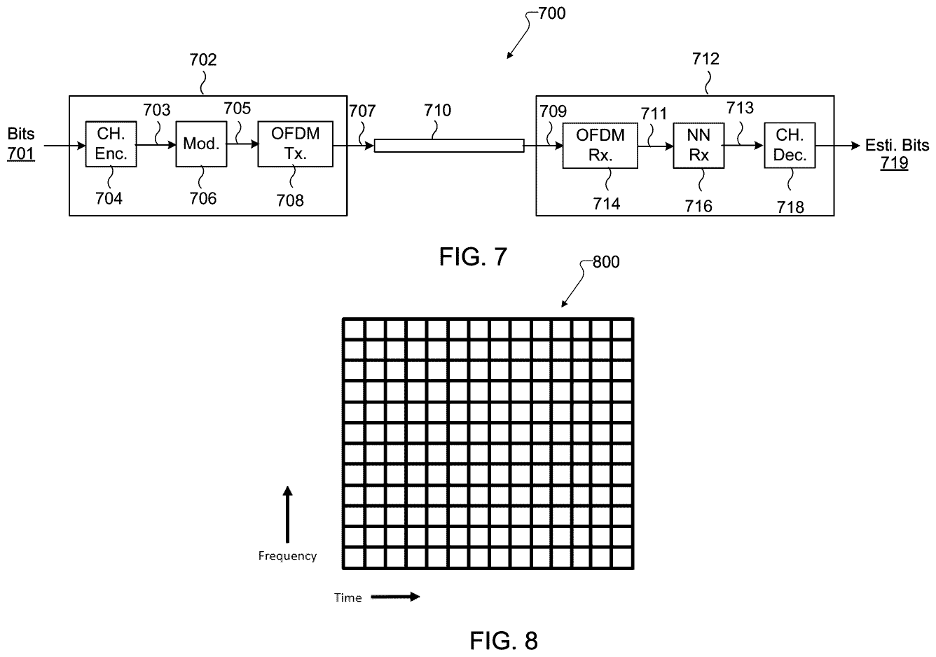

Along with the asymmetric modulation constellations, data-aided transmissions may rely on an NN receiver as illustrated in FIG. 7.

FIG. 7 illustrates an example data-aided communication system 700 in accordance with example embodiments of the present disclosure. The example data-aided communication system 700 as shown in FIG. 7 is for illustration only, and the data-aided communication system 700 could have the same or similar configuration. However, FIG. 7 does not limit the scope of this disclosure to any particular embodiment of data-aided communication systems.

As shown in FIG. 7, the system 700 may include a transmitter architecture 702, a receiver architecture 712 and a wireless channel 710 therebetween. The transmitter architecture 702 may be, e.g., a BS 101-103 of FIGS. 1 and 2, or a UE 111-116 of FIGS. 1 and 3. The receiver architecture 712 may also be, e.g., e.g., a BS 101-103 of FIGS. 1 and 2, or a UE 111-116 of FIGS. 1 and 3. Either or both of the transmitter architecture 702 and the receiver architecture 712 may be AI-based. Hereinafter, the transmitter architecture 702 and the receiver architecture 712 may also be referred to as the Tx architecture and the Rx architecture, respectively. The wireless channel 710 may be, e.g., a band channel.

The Tx architecture 702 may include a channel encoder 704, a modulator 706, and a CP-OFDM transmit device (a CP-OFDM Tx) 708. The channel encoder 704 may receive bits (e.g., a transport block (TB) and/or control information) 701, and perform channel coding on the bits 701 (e.g., low-density parity-check (LDPC) for data and polar for control information) to add redundancy for error correction. The encoded bits 703 may then be scrambled and input to the modulator 706. The modulator 706 may modulate the encoded bits 703 into complex symbols using a constellation such as one of the example constellations 600, 610, 620, 630, 640 in FIG. 6. That is, the channel encoder 704 may take uncoded bits 701 and turn them into coded bits 703, which may then be modulated to constellation symbols by the modulator 706. The modulated symbols 705 may be mapped into REs. The CP-OFDM Tx 708 may perform OFDM processing on the mapped symbols (e.g., domain transform, add CP and upconvert) and transmit the mapped CP-OFDM symbols 707 to the Rx architecture 712 over the channel (also referred to herein as an underlying channel) 710.

The Rx architecture 712 may include a CP-OFDM receive device (a CP-OFDM Rx) 714, an AI model (e.g., a neural network (NN)) 716, and a channel decoder 718. The NN 716 may also be referred to herein as an NN receiver or NN Rx. The CP-OFDM Rx 714 may receive and process the received CP-OFDM symbols 709 (e.g., downconvert, remove CP, and FFT). The NN Rx 716 may perform soft-demodulation on the processed symbols 711 and output log-likelihood ratios (LLRs) 713. The channel decoder 718 may decode the LLRs 713 to estimate the transmitted bits 701 and output the estimated bits 719. Hence, the NN Rx 716 may minimize the error between the output bits 719 from the channel decoder 718 and the input bits 701 fed to the channel encoder 704.

Thus, the data-aided transmissions can be enabled by a combination of an asymmetric modulation constellation 600, 610, 620, 630, 640 and the NN Rx 716, resulting in a reduced RS overhead as illustrated in FIGS. 8 and 18.

FIG. 8 illustrates an example reduced RS overhead 800 in accordance with example embodiments of the present disclosure. The example reduced RS overhead 800 shown in FIG. 8 is for illustration only, and different reduced RS overheads may be achieved using data-aided transmissions.

The example reduced RS overhead 800 may be obtained using the data-aided communication system 700 of FIG. 7.

As shown in FIG. 8, all of the REs in a PRB may contain data symbols. Thus, the data-aided communication system 700 as shown in FIG. 7 may not only reduce, but also effectively eliminate the RS overhead.

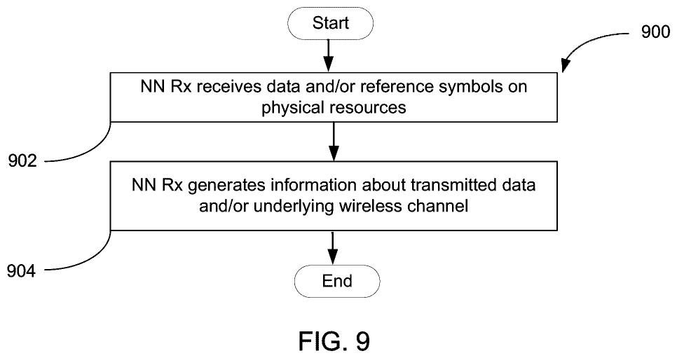

FIG. 9 illustrates an example process 900 of receive operations performed by a Rx architecture to support an NN Rx for data-aided communications in accordance with example embodiments of the present disclosure. The example process 900 shown in FIG. 9 may be performed by the Rx architecture (e.g., an AI-based BS or UE 712 of FIG. 7) or any component thereof. The embodiment of the process illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of the process of receive operations supporting an NN Rx for data-aided communications could be used without departing from the scope of this disclosure.

As shown in FIG. 9, the process 900 begins at step 902. At step 902, the NN Rx (e.g., the NN Rx 716 of FIG. 7) may receive data and/or RS transmitted on physical resources. One example of physical resources may be REs in a time-frequency grid that spans one transmission time interval (TTI). At step 904, the NN Rx may utilize the received data and/or RS to generate information about transmitted data and/or the underlying wireless channel 710.

In one example, the generated information may include LLRs that can be passed to a channel decoder. In another example, the generated information may include soft-demodulated symbols. In yet another example, the generated information can include channel estimates. Soft-demodulated symbols may include symbol-level soft information about the received data. LLRs may include a bit-level soft information computed from the soft-demodulated symbols and quantify the reliability of each individual transmitted bit. In yet another example, the generated information may include estimates of the transmitted bits.

In one example, the NN Rx may include one or more layers that have been trained with a modulation constellation for data-aided communication and an error function.

In FIG. 9, the Rx architecture may utilize the NN Rx to generate information about bits based on received data and/or RS. Alternatively, the NN Rx may receive additional information from a second NN Rx. In this alternative approach, the second NN Rx may generate estimates of the underlying wireless channel and pass those estimates to the first NN Rx.

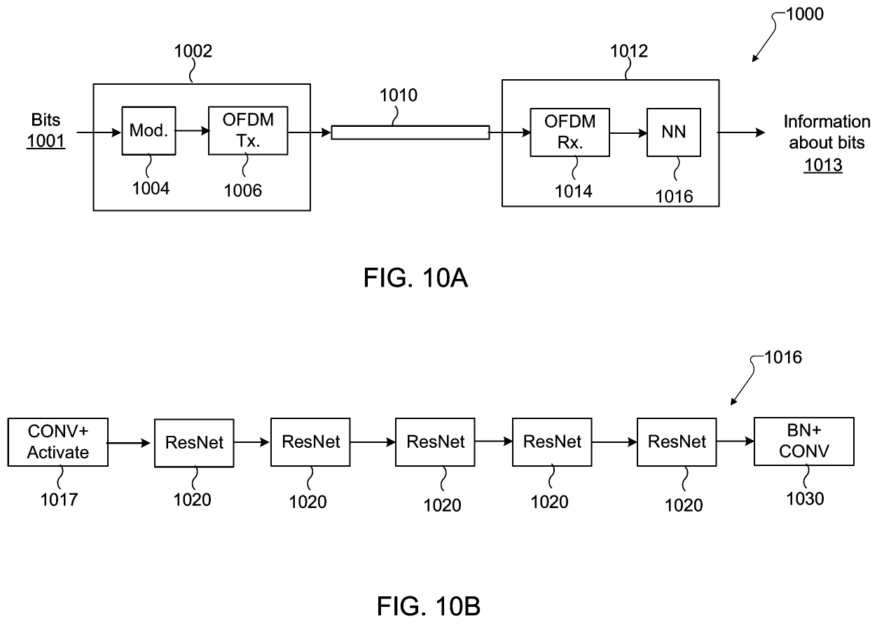

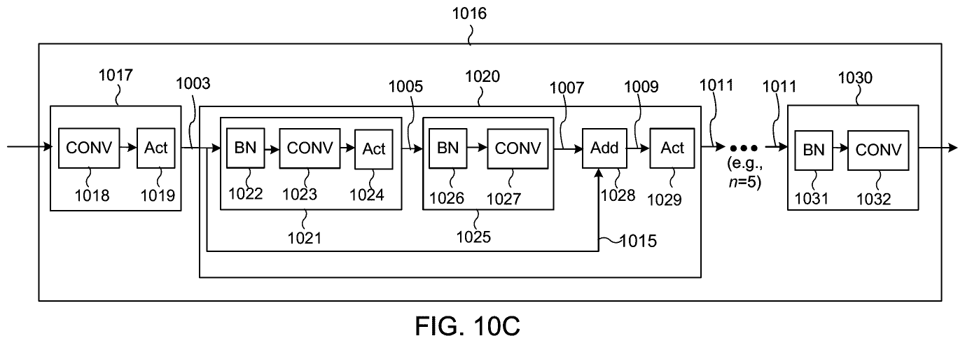

FIGS. 10A-C illustrate an example architecture of an NN Rx 1016 for a data-aided communication system 1000 in accordance with example embodiments of the present disclosure. The NN Rx may be similar or the same as the NN Rx 716 for the data-aided communication system 700 of FIG. 7. The embodiment of the example architecture illustrated in FIGS. 10A-C is for illustration only. One or more of the components illustrated in FIGS. 10A-C may be implemented in specialized circuitry configured to perform the noted functions or one or more of the components may be implemented by one or more processors executing instructions to perform the noted functions. Other embodiments of NN Rx architectures for a data-aided communication system could be used without departing from the scope of this disclosure.

As illustrated in FIG. 10A, the data-aided communication system 1000 may include a Tx architecture (e.g., the Tx architecture 702 of FIG. 7) 1002 and a Rx architecture (e.g., the Rx architecture 712 of FIG. 7) 1012. The Rx architecture 1012 may include and/or support the NN Rx 1016. The Tx architecture 1002 may receive uncoded bits 1001. The modulator 1004 may perform constellation modulation on the bits 1001, and a CP-OFDM Tx 1006 may perform CP-OFDM transmission processing on the modulated symbols. The processed OFDM symbols may be transmitted to the Rx architecture 1012 over a channel 1010. The CP-OFDM Rx 1014 may perform CP-OFDM reception processing on the received symbols. The NN Rx 1016 may perform soft demodulation on the processed symbols and output information 1013 about the bits 1001. The NN Rx 1016 is discussed further with reference to FIGS. 10B-C.

As illustrated in FIG. 10B, the NN Rx 1016 may include an initial convolution (CONV) block 1017 including an initial CONV layer 1018 followed by an initial nonlinear activation function 1019, multiple serially-connected “ResNet” blocks (ResNet) 1020, a final CONV block 1030 including a BN layer 1031 followed by a final CONV layer 1032. While FIG. 10B shows five ResNet 1020 within the NN Rx 1016, this is for illustrative purposes only, and thus any other number of ResNet 1020 can be utilized for deep learning and refinement. Further, other deep learning algorithms in addition or alternative to ResNet may be utilized.

FIG. 10C illustrates the NN Rx 1016 in further detail. As shown in FIG. 10C, the initial CONV layer 1018 may perform the initial convolution (e.g., apply filters to the symbols and extract linear feature maps) on the received symbols. The initial nonlinear activation function 1019 may introduce nonlinearity element-wise to the feature maps and output nonlinear feature maps 1003 to the ResNet 1020 for deeper processing and skip connection. Note that the output of the initial CONV layer 1018 may be passed through an activation function (e.g., an ELU, ReLU, LeakyLU and other non-linear activation function) to avoid consecutive linear operations, thus facilitating training convergence.

In this example, each ResNet 1020 may include a first subblock 1021, a second subblock 1025, an addition operation 1028, and an activation function 1029. The first subblock 1021 may include a first BN layer 1022, a first CONV layer 1023, and a first nonlinear activation function 1024, in that order. The nonlinear feature maps 1003 from the initial nonlinear activation function 1019 may be input to the first subblock 1021 for normalization by the first BN layer 1022, further convolutional filtering by the first CONV layer 1023 to extract refined linear feature maps, and further element-wise nonlinearity refinement by the first nonlinear activation function 1024 to generate refined nonlinear feature maps 1005. Note that the first nonlinear activation function 1019 may be utilized here after the batch normalization 1022 and convolution 1023 so as to avoid issues with dead neurons.

The second subblock 1025 may include a second BN layer 1026 followed by a second CONV layer 1027. The refined nonlinear feature maps 1005 may be input to the second subblock 1025 for further refinement. The second BN layer 1026 may perform normalization and the second CONV layer 1027 may perform further convolutional filtering to extract refined linear feature maps 1007 from the refined nonlinear feature maps 1005.

The addition operation 1028 may perform residual addition by combining the refined linear feature maps 1007 with the input (the nonlinear feature maps 1003) via skip connection 1015. The second nonlinear activation function 1029 may introduce nonlinearity to the combined feature maps 1009 to generate further refined nonlinear feature maps 1011. Note that the second nonlinear activation function 1029 may also be utilized here after the batch normalization 1026 and convolution 1027 so as to avoid the issues with dead neurons.

The further refined nonlinear feature maps 1011 may be input to the next ResNet 1020 for even further refinement until the last ResNet 1020 has performed the last refinement. The number n of the ResNet 1020 in the NN Rx 1016 may be any number, e.g., 5, allowing deep learning for the NN Rx 1016. The final nonlinear feature maps 1011 output from the last ResNet 1020 may pass through the final CONV block 1030 including a BN layer 1031 and a final CONV layer 1032 to, e.g., facilitate training convergence. Upon the normalization, the CONV layer 1032 may process the final nonlinear feature maps 1011 to produce bit-wise soft decisions (e.g., LLRs for each bit position) by implicitly estimating the OFDM symbol's location within the modulation constellation. The NN Rx 1016 may then output information (e.g., the soft decisions) about the transmitted bits 1001 to facilitate data-aided communications.

One example of a nonlinear activation function may be an exponential linear unit (ELU) activation function as following:

$$E L U ( x ) = \{ \begin{matrix}α ( {e}^{x} - 1 ) , x < 0 \\ x , x \geq 0\end{matrix} \qquad ( 1 )$$

Here, α is a hyperparameter.

Another example of a nonlinear activation function may be a rectified linear unit (ReLU) activation function as following:

$$ReL U ( x ) = \{ \begin{matrix}0 , x < 0 \\ x , x \geq 0\end{matrix} \qquad ( 2 )$$

Yet another example of a nonlinear activation function may be a Leaky ReLU activation function as following:

$$LeakyReL U ( x ) = \{ \begin{matrix}α x , x < 0 \\ x , x \geq 0\end{matrix} \qquad ( 3 )$$

Other examples of nonlinear activation functions may include the sigmoid and/or tanh activation functions.

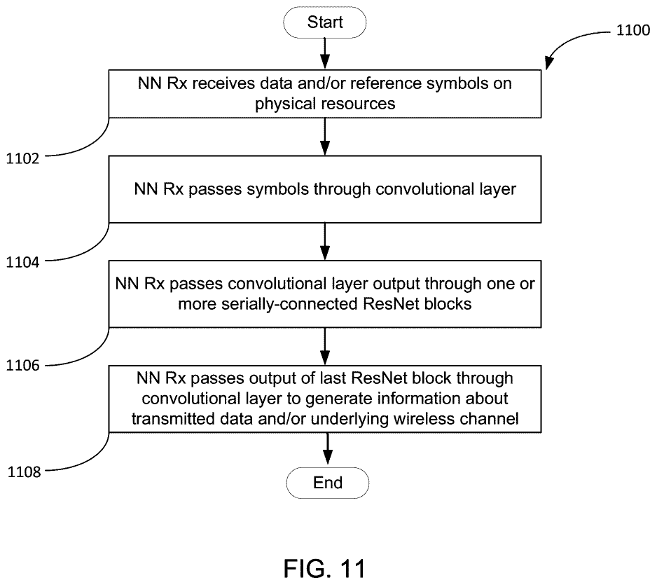

FIG. 11 illustrates an example process 1100 of receive operations performed by an Rx architecture for data-aided communications in accordance with example embodiments of the present disclosure. The example process 1100 shown in FIG. 11 may be performed by the Rx architecture (e.g., an AI-based BS or UE 712, 1012 of FIGS. 7 and 10A) or any component (e.g., the CP-OFDM receiver 714, 1014 or the NN Rx 716, 1016 of FIGS. 7 and 10A) thereof. The embodiment of the process illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of the process for receive operations for data-aided communications could be used without departing from the scope of this disclosure.

As shown in the example of FIG. 11, the process 1100 begins at step 1102. At step 1102, the CP-OFDM receiver may receive data and/or RS on physical resources. One example of physical resources may be REs in a time-frequency grid that spans one TTI.

At step 1104, the NN Rx may pass received symbols through a CONV layer (e.g., the initial CONV layer 1018 of FIG. 10C). At step 1106, the NN Rx may pass the output of the initial CONV layer through one or more serially-connected ResNet blocks (e.g., the ResNet 1020 of FIGS. 10B-C).

At step 1108, the NN Rx may pass the output of the last ResNet block through a final CONV layer (e.g., the final CONV layer 1032 of FIG. 10C) to generate information about transmitted data and/or the underlying wireless channel (e.g., the channel 710, 1010 of FIGS. 7 and 10A). In one embodiment, the NN Rx may pass the output of the last ResNet block through the final CONV layer to generate channel estimates. The number of output channels in the final CONV layer can be set to “2” to correspond to the {magnitude, phase} or {real part, imaginary part} for the generated complex-valued channel estimates for one TTI and/or for each RE. In another embodiment, the {real part, imaginary part} output of the final CONV layer can be further normalized to a unit magnitude.

In one example, the generated information may include LLRs that can be passed to a channel decoder. In another example, the generated information may include soft-demodulated symbols corresponding to the transmitted modulation symbols. In another example, the generated information may include channel estimates. In another example, the generated information may include estimates of the transmitted bits. In another example, the generated information may include estimates of the SNR.

In FIG. 11, the Rx architecture may utilize the NN Rx to generate information about bits based on received data and/or RS. Alternatively, the NN Rx may receive additional information from a second NN Rx. In this alternative approach, the second NN Rx may generate estimates of the underlying wireless channel and pass those estimates to the first NN Rx.

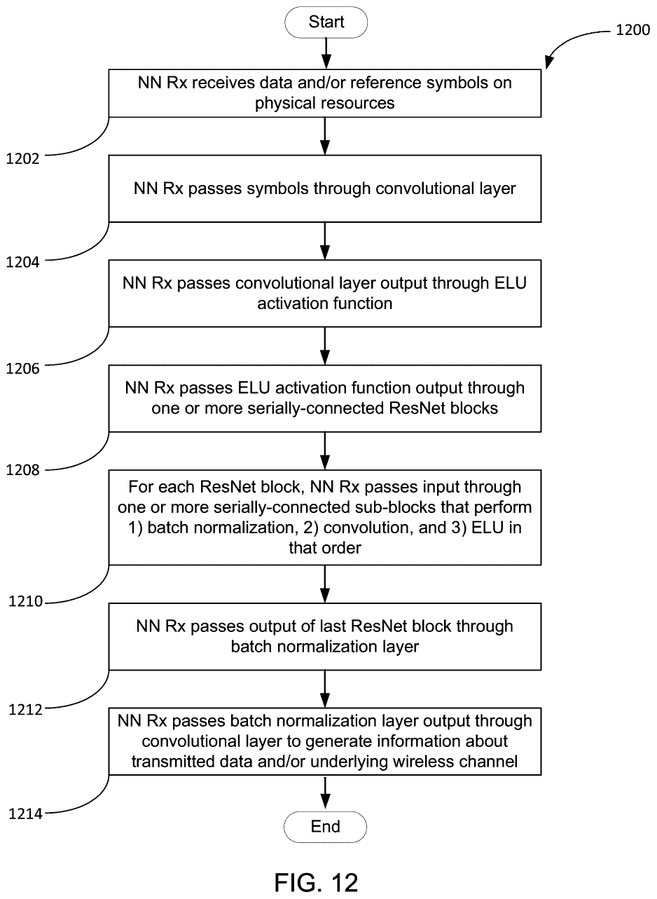

FIG. 12 illustrates an example process 1200 of receive operations performed by an Rx architecture for data-aided communications in accordance with example embodiments of the present disclosure. The example process 1200 shown in FIG. 12 may be performed by the Rx architecture (e.g., an AI-based BS or UE 712, 1012 of FIGS. 7 and 10A) or any component (e.g., the NN Rx 716, 1016 of FIGS. 7 and 10A-C) thereof. The embodiment of the process illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of the process for receive operations for data-aided communications could be used without departing from the scope of this disclosure. For example, while the example process 1200 may be performed by an NN Rx including ELU activation functions, it may be performed by an NN Rx including any other nonlinear activation functions as appropriate.

As shown in the example of FIG. 12, the process 1200 begins at step 1202. At step 1202, the NN Rx may receive data and/or RS on physical resources. One example of physical resources may be REs in a time-frequency grid that spans one TTI. At step 1204, the NN Rx may pass received symbols through a CONV layer. At step 1206, the NN Rx may pass the output of the CONV layer through an ELU activation function. In one example, step 1204 may be skipped, and the NN Rx can directly pass received symbols through an ELU activation function (step 1206).

At step 1208, the NN Rx may pass the output of the ELU activation function through one or more serially-connected ResNet blocks. Applying an ELU or any other nonlinear activation function at step 1206 may effectively avoid consecutive linear operations (i.e., the CONV layer at step 1204 and the first BN in the first ResNet block at step 1208). This may facilitate convergence during training of the NN.

At step 1210, the NN Rx may pass input through a series of ResNet blocks. Each ResNet block may include a BN layer, a CONV layer, and an ELU activation function, in that order. The NN Rx may pass the input through one or more of these serially-connected sub-blocks. Applying ELU activation functions at steps 1206 and 1210 can address issues with dead neurons that have been observed when applying other nonlinear activation functions. The order of operations in the sub-block at step 1210 may differ from that in a standard ResNet block, yet this ordering can also facilitate convergence during the NN Rx training.

At step 1212, the NN Rx may pass the output of the last ResNet block through a BN layer. Applying a BN layer at step 1212 may also facilitate convergence during the NN Rx training and the presence of the BN layer can impact the achievable performance of the NN.

At step 1214, the NN Rx may pass the output of the BN layer through a CONV layer to generate information about transmitted data and/or the underlying wireless channel.

In another example, at step 1214, the NN Rx may pass the output of the BN layer through a CONV layer to generate channel estimates. The number of output channels in the CONV layer can be set to “2” to correspond to the {magnitude, phase} or {real part, imaginary part} for the generated complex-valued channel estimates. In one example, the generated information can include LLRs that can be passed to a channel decoder. In another example, the generated information can include soft-demodulated symbols. In yet another example, the generated information can include channel estimates. In yet another example, the generated information can include estimates of the transmitted bits.

In one example, after step 1214, the NN Rx can perform an additional operation at step 1216 and pass the output of the CONV layer through a reshape layer to facilitate downstream processing.

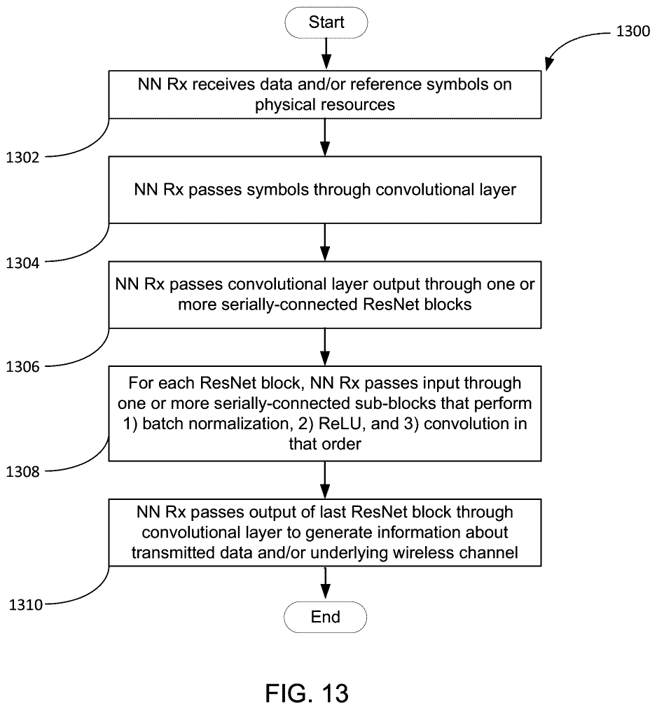

FIG. 13 illustrates an example process 1300 of receive operations performed by an Rx architecture for data-aided communications in accordance with example embodiments of the present disclosure. The example process 1300 shown in FIG. 13 may be performed by the Rx architecture (e.g., an AI-based BS or UE 712, 1012 of FIGS. 7 and 10A) or any component (e.g., the NN Rx 716, 1016 of FIGS. 7 and 10A-C) thereof. The embodiment of the process illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of the process for receive operations for data-aided communications could be used without departing from the scope of this disclosure. For example, while the example method 1300 may be performed by an NN Rx including ReLU activation functions, it may be performed at an NN Rx including any other nonlinear activation functions as appropriate.

As shown in the example of FIG. 13, the process 1300 begins at step 1302. At step 1302, the NN Rx may receive data and/or RS on physical resources. One example of physical resources may be REs in a time-frequency grid that spans one TTI. At step 1304, the NN Rx may pass received symbols through a CONV layer. At step 1306, the NN Rx may pass the output of the CONV layer through one or more serially-connected ResNet blocks. At step 1308, the NN Rx may pass input through a series of ResNet blocks. Each ResNet block may include a BN layer, a ReLU activation function, and a CONV layer, in that order.

At step 1310, the NN Rx may pass the output of the last ResNet block through a CONV layer to generate information about transmitted data or/and the underlying wireless channel. In another example, at step 1310, the NN Rx may pass the output of the last ResNet block through a CONV layer to generate channel estimates. In one example, the generated information may include LLRs that can be passed to a channel decoder. In another example, the generated information may include soft-demodulated symbols. In yet another example, the generated information may include channel estimates. In yet another example, the generated information may include estimates of the transmitted bits.

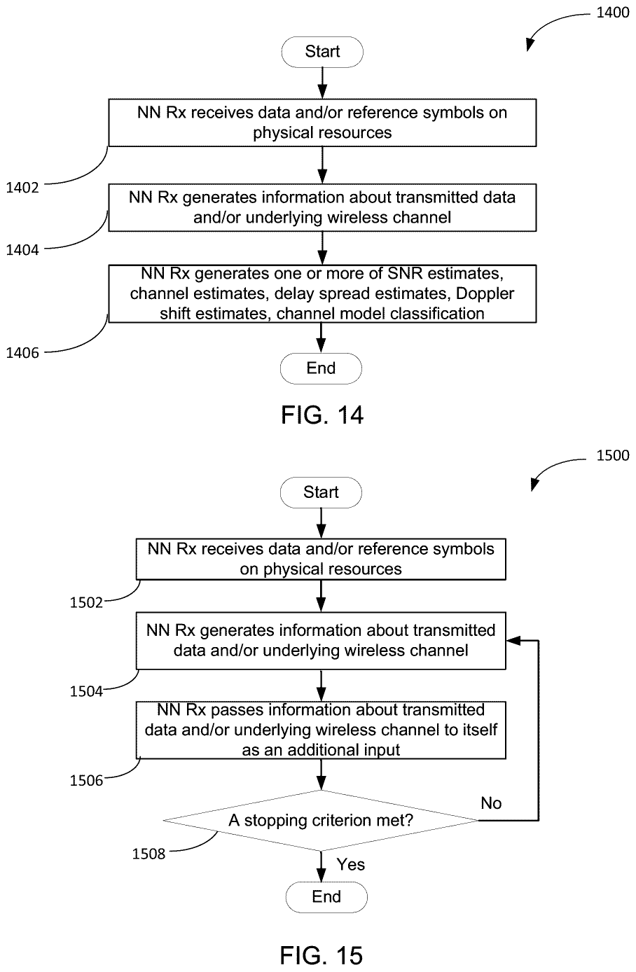

FIG. 14 illustrates an example process 1400 of receive operations performed by a receiver for data-aided communications in accordance with example embodiments of the present disclosure. The example process 1400 shown in FIG. 14 may be performed by the Rx architecture (e.g., an AI-based BS or UE 712, 1012 of FIGS. 7 and 10A) or any component (e.g., the NN Rx 716, 1016 of FIGS. 7 and 10A-C) thereof. In this embodiment, the NN Rx may generate supplemental information. The embodiment of the process illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of the process for receive operations for data-aided communications could be used without departing from the scope of this disclosure.

As shown in the example of FIG. 14, the process 1400 begins at step 1402. At step 1402, the NN Rx may receive data and/or RS on physical resources. One example of physical resources may be REs in a time-frequency grid that spans one TTI.

At step 1404, the NN Rx may utilize the received data and/or RS to generate information about transmitted bits. In one example, the generated information may include LLRs that can be passed to a channel decoder. In another example, the generated information may include soft-demodulated symbols. In yet another example, the generated information may include channel estimates. In another example, the generated information may include estimates of the transmitted bits.

At step 1406, the NN Rx may utilize the received data and/or RS to generate one or more of SNR estimates, channel estimates, delay spread estimates, Doppler shift estimates, and channel model classification.

In one example, the NN Rx in the process 1400 may include one or more layers that have been trained with a modulation constellation for data-aided communication and an error function.

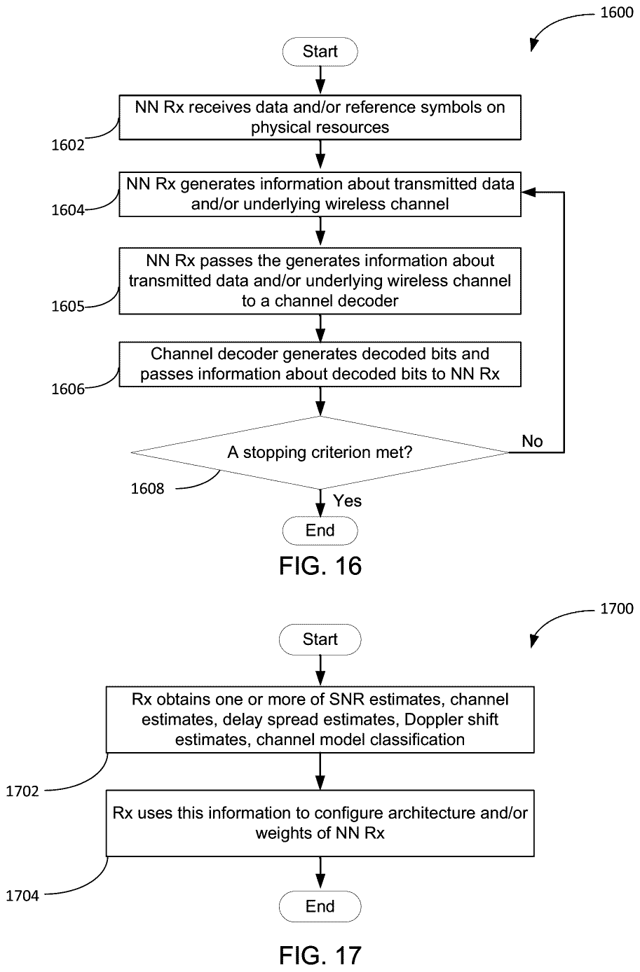

FIGS. 15 and 16 illustrate example processes 1500, 1600 of receive operations performed by an Rx architecture for data-aided communications in accordance with example embodiments of the present disclosure. The example processes 1500, 1600 shown in FIGS. 15 and 16 may be performed by the Rx architecture (e.g., an AI-based BS or UE 712, 1012 of FIGS. 7 and 10A) or any component (e.g., the NN Rx 716, 1016 of FIG. 7 or 10A-C) thereof. In this embodiment, the NN Rx may perform iterative processing. The embodiments of the processes illustrated in FIGS. 15 and 16 are for illustration only. One or more of the components illustrated in FIGS. 15 and 16 may be implemented in specialized circuitry configured to perform the noted functions or one or more of the components may be implemented by one or more processors executing instructions to perform the noted functions. Other embodiments of the processes for receive operations for data-aided communications could be used without departing from the scope of this disclosure.

As shown in the example of FIG. 15, the process 1500 begins at step 1502. At step 1502, the NN Rx may receive data and/or RS on physical resources. One example of physical resources may be REs in a time-frequency grid that spans one TTI. At step 1504, the NN Rx may utilize the received data and/or RS to generate information about transmitted data and/or the underlying wireless channel. At step 1506, the NN Rx may utilize its generated information about transmitted data and/or the underlying wireless channel as an additional input for another processing iteration that corresponds to step 1504. At step 1508, the NN Rx may repeat steps 1504 and 1506 until a stopping criterion is achieved.

As illustrated in FIG. 16, between steps 1504 and 1506, the NN Rx can perform an additional operation at step 1605. At step 1605, upon the NN Rx can pass its generated information about transmitted data and/or the underlying wireless channel to a channel decoder. In this case, step 1606 can be modified to have a channel decoder generate decoded bits and pass information about the decoded bits to the NN. In this example, steps 1608 can be modified to have the NN Rx repeat steps 1604, 1605 and 1606 until a stopping criterion is achieved.

One example of a stopping criterion may be a maximum absolute value of the difference between output symbols over consecutive iterations decreasing below a threshold. One example of this threshold may be a configurable multiple of the nearest-neighbor distance in a modulation constellation. Another example of a stopping criterion may be a number of iterations reaching a threshold. One example of this threshold may correspond to a time limit for online training. Another example of a stopping criterion may be a channel decoder reporting that its CRC has passed and/or its decoding operation has succeeded.

In one example, the generated information may include LLRs that can be passed to a channel decoder. In another example, the generated information may include soft-demodulated symbols. In yet another example, the generated information may include channel estimates. In yet another example, the generated information may include estimates of the transmitted bits.

In one example, the NN Rx in the processes 1500, 1600 may include one or more layers that have been trained with a modulation constellation for data-aided communication and an error function.

FIG. 17 illustrates an example process 1700 of receive operations performed by an Rx architecture for data-aided communications in accordance with example embodiments of the present disclosure. The example process 1700 shown in FIG. 17 may be performed by the Rx architecture (e.g., an AI-based BS or UE 712, 1012 of FIG. 7 or 10A) or any component (e.g., the NN Rx 716, 1016 of FIG. 7 or 10A-C) thereof. The embodiment of the process illustrated in FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments of the process for receive operations for data-aided communications could be used without departing from the scope of this disclosure.

As shown in the example of FIG. 17, the process 1700 begins at step 1702. At step 1702, the Rx architecture may obtain one or more of SNR estimates, channel estimates, delay spread estimates, Doppler shift estimates, and channel model classification. At step 1704, the Rx architecture may utilize this information to configure the NN Rx architecture and/or weights.

In one example, at step 1702, the Rx architecture may obtain this information in a non-AI-based method. In another example, the Rx architecture may obtain this information from an AI-based method.

In one example, the NN Rx at step 1704 may include one or more layers that have been trained with a modulation constellation for data-aided communication and an error function.

FIG. 18 illustrates example DMRS patterns 1800, 1810 that can be configured for data-aided transmission in accordance with example embodiments of the present disclosure. The example DMRS patterns 1800, 1810 shown in FIG. 18 are for illustration only, and DMRS patterns 1800, 1810 could have the same or similar configuration. However, FIG. 18 does not limit the scope of this disclosure to any particular modulation constellations.

Both example DMRS patterns 1800, 1810 shown in FIG. 18 support tracking of time-frequency channel variations since the REs 502 with RS are evenly spaced in both time and frequency. That is, the known RSs can be utilized to perform more explicit and accurate channel estimation, which in turn may be fed to an NN Rx (e.g., NN Rx 716, 1016 of FIG. 7 or 10). This may be advantageous in that the RS overhead may be reduced significantly in these patterns 1800, 1810 while also utilizing the known RS for more accurate channel estimation for the entire RB. As shown in FIG. 18, both example DMRS patterns 1800, 1810 have less RS overhead than the example 500 in FIG. 5. That is, 6 and 4 out of 168 REs in the example DMRS patterns 1800, 1810, respectively, include the RS as compared to 12 out of the 168 REs in the example RS pattern 500 in FIG. 5.

Further, the example DMRS pattern 1810 may have even less RS overhead than that of the example DMRS pattern 1800.

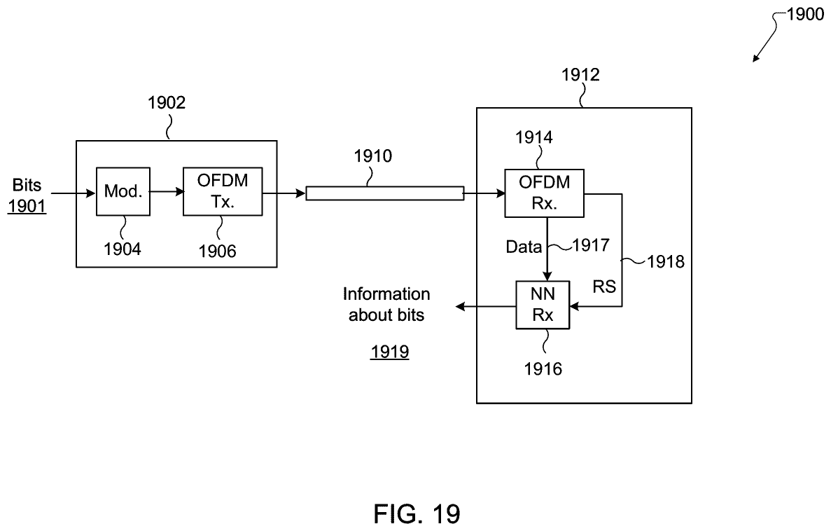

FIG. 19 illustrates an example architecture 1900 of an Rx architecture 1912 for data-aided transmission with an RS in accordance with example embodiments of the present disclosure. The embodiment of the example architecture illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of the Rx architecture for data-aided transmission could be used without departing from the scope of this disclosure.

As illustrated in FIG. 19, the Rx architecture 1912 may be similar to the Rx architecture 712, 1012 of FIG. 7 or 10A, except that the CP-OFDM receiver 1914 pass, to the NN Rx 1916, data and RS over separate channels 1917 and 1918, respectively. For example, the input to the NN Rx 1916 may include 16 channels, which in turn may include, e.g., 12 data channels and 4 RS channels. Thus, the NN Rx 1916 may receive data over the 12 data channels and the RS in the 4 RS channels. The NN Rx 1916 may next perform the soft demodulation to generate information 1919 about, e.g., the transmitted bits 1901 and explicit channel estimates.

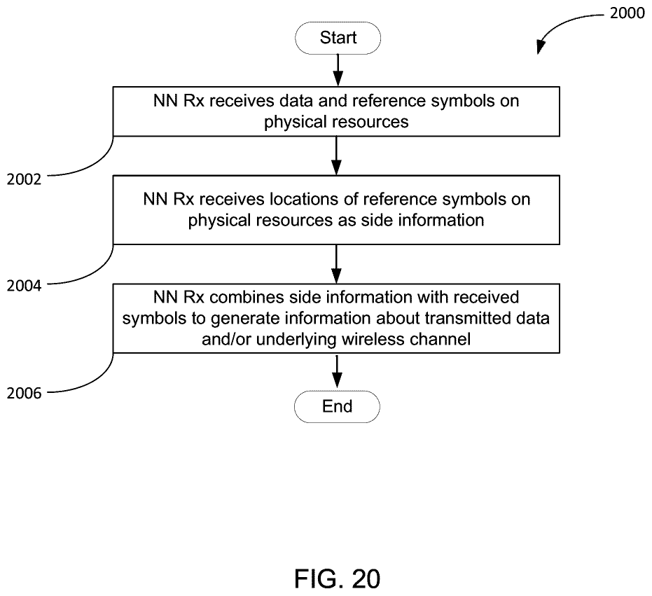

FIG. 20 illustrates an example process 2000 of receive operations performed by an Rx architecture for data-aided communications with an RS in accordance with example embodiments of the present disclosure. The example process 2000 shown in FIG. 20 may be performed by the Rx architecture (e.g., an AI-based BS or UE 712, 1012 of FIG. 7 or 10A) or any component (e.g., the NN Rx 716, 1016 of FIG. 7 or 10A-C) thereof. The embodiment of the process illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of the process for receive operations for data-aided communications could be used without departing from the scope of this disclosure.

In the example shown in FIG. 20, the process 2000 begins at step 2002. At step 2002, the NN Rx may receive data and RS on physical resources. One example of physical resources may be REs in a time-frequency grid that spans one TTI. At step 2004, the NN Rx may receive locations of the RS on physical resources as side information. One example of physical resources may be REs in a time-frequency grid that spans one TTI. One example of side information may be a binary mask over a time-frequency grid that spans one TTI, where a “1” corresponds to the location of an RS while a “0” corresponds to the location of a data symbol. At step 2006, the NN Rx may combine the side information with the received data and RS to generate information about transmitted data and/or the underlying wireless channel.

In one example, regular (e.g., standard) modulation constellations can be leveraged in the process 2000. Since the NN Rx may receive RSs along with side information about the locations of these RSs, it can use this information to estimate—and compensate for—amplitude and phase impairments (e.g., a phase rotation of at least 90 degrees) that are introduced by the underlying wireless channel. This may address the issue of phase ambiguity for the regular modulation constellations from the discussion with reference to FIG. 6. Also, since the NN Rx can obtain rough channel estimates from the received RSs, the number of output channels in each CONV layer—and, hence, the complexity of the NN Rx—can be reduced.

In one example, the generated information may include LLRs that can be passed to a channel decoder. In another example, the generated information may include soft-demodulated symbols. In yet another example, the generated information may include channel estimates. In yet another example, the generated information may include estimates of the transmitted bits.

In one example, the NN Rx in the method 2000 may include one or more layers that have been trained with a modulation constellation for data-aided communication and an error function.

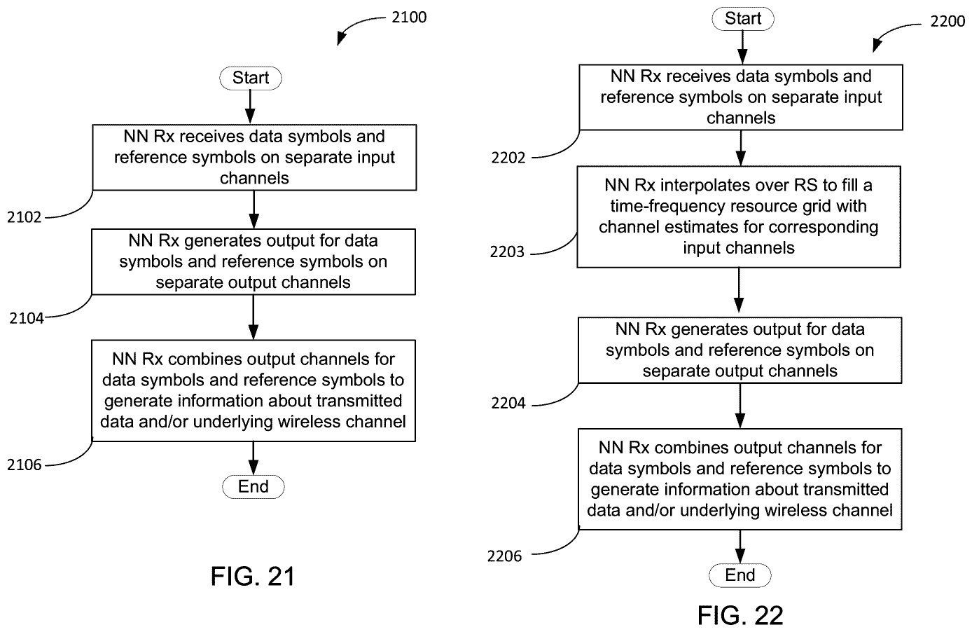

FIGS. 21 and 22 illustrate example processes 2100, 2200 of receive operations performed by an Rx architecture for data-aided communications with RSs on separate channels in accordance with example embodiments of the present disclosure. The example processes 2100, 2200 shown in FIGS. 21 and 22 may be performed by the Rx architecture (e.g., an AI-based BS or UE 712, 1012 of FIG. 7 or 10A) or any component (e.g., the NN Rx 716, 1016 of FIG. 7 or 10A-C) thereof. The embodiments of the processes illustrated in FIGS. 21 and 22 are for illustration only. One or more of the components illustrated in FIGS. 21 and 22 may be implemented in specialized circuitry configured to perform the noted functions or one or more of the components may be implemented by one or more processors executing instructions to perform the noted functions. Other embodiments of the process for receive operations for data-aided communications could be used without departing from the scope of this disclosure.

In the example embodiment shown in FIG. 21, the process 2100 begins at step 2102. At step 2102, the NN Rx may receive data and RS on separate input channels (as illustrated in FIG. 19). At step 2104, the NN Rx may generate an output for data symbols and RS on separate output channels. At step 2106, the NN Rx may combine output channels for data symbols and RS to generate information about transmitted data and/or the underlying wireless channel.

As illustrated in FIG. 22, in one example, between steps 2102 and 2104, the Rx architecture can perform an additional operation at step 2203. At step 2203, the NN Rx can interpolate over RS to fill a time-frequency resource grid with channel estimates for the corresponding input channels. In one example, the interpolation method in step 2203 can be linear interpolation. In another example, the interpolation method in step 2203 can be a cubic spline. In yet another example, the interpolation method in step 2203 can be a 2-D Wiener filter that utilizes channel statistical information. In yet another example, the interpolation method in step 2203 can entail dividing the time-frequency resource grid into sections and performing separate interpolation for each section.

In one example, the generated information at step 2106 or 2206 can include LLRs that can be passed to a channel decoder. In another example, the generated information can include soft-demodulated symbols. In another example, the generated information can include channel estimates. In another example, the generated information can include estimates of the transmitted bits.

In one example, for step 2106 or 2206, the output channels for the RS can correspond to equalizer coefficients that the NN Rx can then apply to the output channels for data symbols to generate information about transmitted bits.

In one example, the NN Rx in the process 2100 or 2200 can include one or more layers that have been trained with a modulation constellation for data-aided communication and an error function.

Table 1 below shows an example NN Rx architecture for data-aided communication. The number of ResNet blocks can be set to, e.g., five with each ResNet block including two serially-connected sub-blocks in the form of (a BN layer+a CONV layer+an ELU activation function) and (a BN layer+a CONV layer+an add block+an ELU activation function), respectively. Note that the five ResNet blocks may be the core of this NN Rx.

TABLE 1
Example NN Rx Architecture for Data-aided Communication

| | Output |
|---|---|
| Layers | Dimensions |
| Input | 2 × 120 × 14 |
| CONV + ELU | 128 × 120 × 14 |
| (BN + CONV + ELU) + (BN + CONV + add + ELU) | 128 × 120 × 14 |
| (BN + CONV + ELU) + (BN + CONV + add + ELU) | 128 × 120 × 14 |
| (BN + CONV + ELU) + (BN + CONV + add + ELU) | 128 × 120 × 14 |
| (BN + CONV + ELU) + (BN + CONV + add + ELU) | 128 × 120 × 14 |
| (BN + CONV + ELU) + (BN + CONV + add + ELU) | 128 × 120 × 14 |
| BN + CONV | 6 × 120 × 14 |
| Reshape | 1680 × 6 |

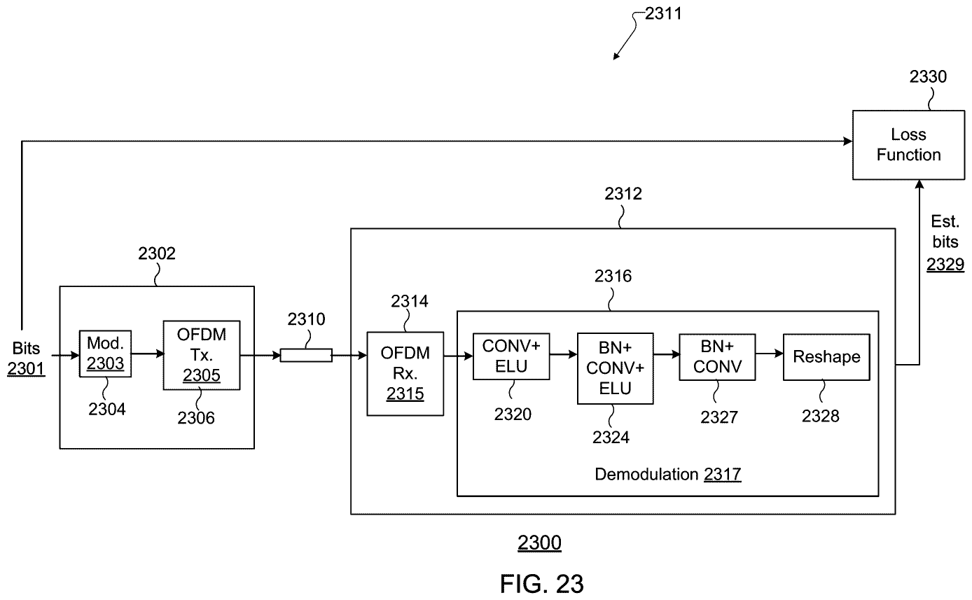

FIG. 23 illustrates an example pipeline 2300 for training an NN Rx 2316 in a data-aided communication system 2311 accordance with example embodiments of the present disclosure. The embodiment of the example pipeline illustrated in FIG. 23 is for illustration only. One or more of the components illustrated in FIG. 23 may be implemented in specialized circuitry configured to perform the noted functions or one or more of the components may be implemented by one or more processors executing instructions to perform the noted functions. Other embodiments of example pipelines for training an NN Rx could be used without departing from the scope of this disclosure.

As illustrated in FIG. 23, the pipeline 2300 may include a modulation operation 2303, a CP-OFDM transmission processing operation 2305, a CP-OFDM reception processing operation 2315, a soft demodulation operation 2317, and a loss function 2330. The modulation operation 2303 and the CP-OFDM transmission processing operation 2305 may be performed by a Tx architecture (e.g., the Tx architecture 702, 1002 of FIGS. 7 and 10A) and the CP-OFDM reception processing operation 2315 and the soft-demodulation operation 2317 may be performed by an Rx architecture (e.g., the Rx architecture 712, 1012 of FIG. 7 or 10A). The loss function 2330 may be performed by the Rx architecture or a network server (e.g., the server 132 of FIGS. 1 and 4). More or less operations may be performed at the Tx architecture 2302 and/or the Rx architecture 2312.

In the example embodiment shown in FIG. 23, the bits 2301 may be input to the Tx architecture 2302 for the modulation operation 2303 and the CP-OFDM transmission processing operation 2305. The processed OFDM symbols may be transmitted over a channel 2310 to the Rx architecture 2312. The CP-OFDM receiver 2314 of the Rx architecture 2312 may perform the CP-OFDM reception processing operation 2315 on the received symbols and input the processed symbols to the NN Rx 2316 for the soft demodulation operation 2317. The NN Rx 2316 may be similar to the NN Rx 716, 1016 of FIG. 7 or 10A-C, but differs in that it includes a reshape function 2328. This is for illustration purposes only, and thus other example NNs may be utilized to perform soft demodulation without departing from the scope of this disclosure. While it is not shown in FIG. 23, the NN Rx 2316 may also include multiple ResNet in series as shown in FIG. 10.

In this embodiment, the output of the NN Rx 2316 may include estimated bits 2329. The estimated bits 2329 may be passed to the loss function 2330. The loss function 2330 may compare the estimated bits 2329 with the bits 2301 that are input to the modulator 2304, and the resulting error may be utilized to update the weights of the NN Rx 2316.

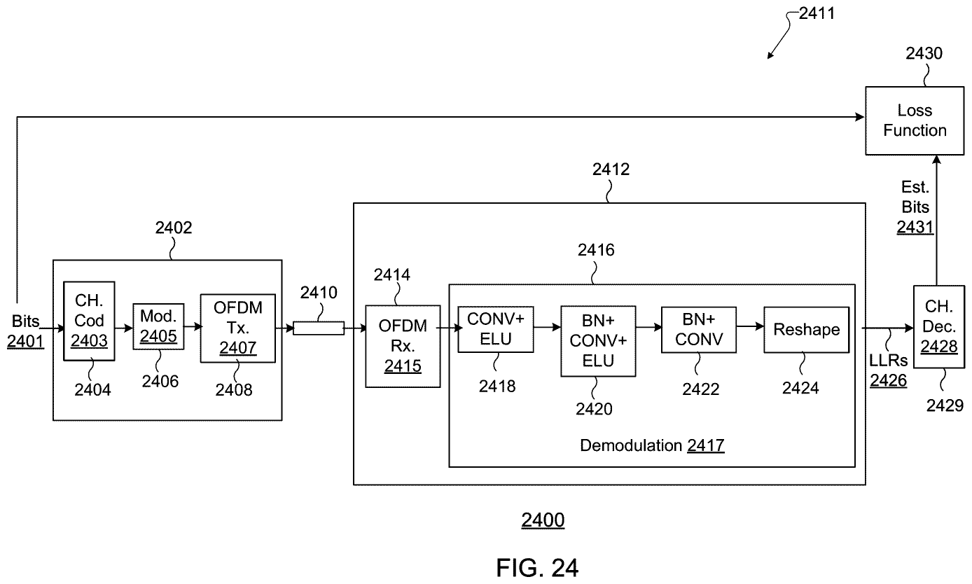

FIG. 24 illustrates an example pipeline 2400 for training an NN Rx 2416 with channel coding operation 2403 in a data-aided communication system 2411 in accordance with example embodiments of the present disclosure. The pipeline 2400 and the data-aided communication system 2411 are similar to the process 2300 and the data-aided communication system 2311 of FIG. 23, except for the inclusion of the channel coding and decoding operations 2403 and 2428. The embodiment of the example pipeline illustrated in FIG. 24 is for illustration only. One or more of the components illustrated in FIG. 24 may be implemented in specialized circuitry configured to perform the noted functions or one or more of the components may be implemented by one or more processors executing instructions to perform the noted functions. Other embodiments of example pipeline for training an NN Rx could be used without departing from the scope of this disclosure.

As illustrated in FIG. 24, the pipeline 2400 may include a channel encoding operation 2403, a modulation operation 2405, a CP-OFDM transmission processing operation 2407, a CP-OFDM reception processing operation 2415, a soft demodulation operation 2417, a channel decoding operation 2428, and a loss function 2430. The channel encoding operation 2403, modulation operation 2405 and the CP-OFDM transmission processing operation 2407 may be performed by a Tx architecture (e.g., the Tx architecture 702, 1002 of FIG. 7 or 10A) and the CP-OFDM reception processing operation 2415, the soft-demodulation operation 2417 and the channel decoding operation 2428 may be performed by an Rx architecture (e.g., the Rx architecture 712, 1012 of FIG. 7 or 10A-C). The loss function 2430 may be performed by the Rx architecture or a network server (e.g., the server 132 of FIGS. 1 and 4). More or less operations may be performed at the Tx architecture 2402 and/or the Rx architecture 2412.

In the example embodiment shown in FIG. 24, the bits 2401 may be input to the Tx architecture 2402 for the channel coding operation 2403 by a channel coder 2404, the modulation operation 2405 by a modulator 2406 and the CP-OFDM transmission processing operation 2407 by a CP-OFDM Tx 2408. The processed OFDM symbols may be transmitted over a channel 2410 to the Rx architecture 2412. The CP-OFDM Rx 2414 of the Rx architecture 2412 may perform the CP-OFDM reception processing operation 2415 on the received symbols and input the processed symbols to the NN Rx 2416 for the soft demodulation operation 2417. The NN Rx 2416 may be similar to the NN Rx 2316 of FIG. 23, and include a reshape function 2424. This is for illustration purposes only, and thus other example NNs may be utilized to perform soft demodulation without departing from the scope of this disclosure. While it is not shown in FIG. 24, the NN Rx 2416 may also include multiple ResNet in series as shown in FIG. 10.

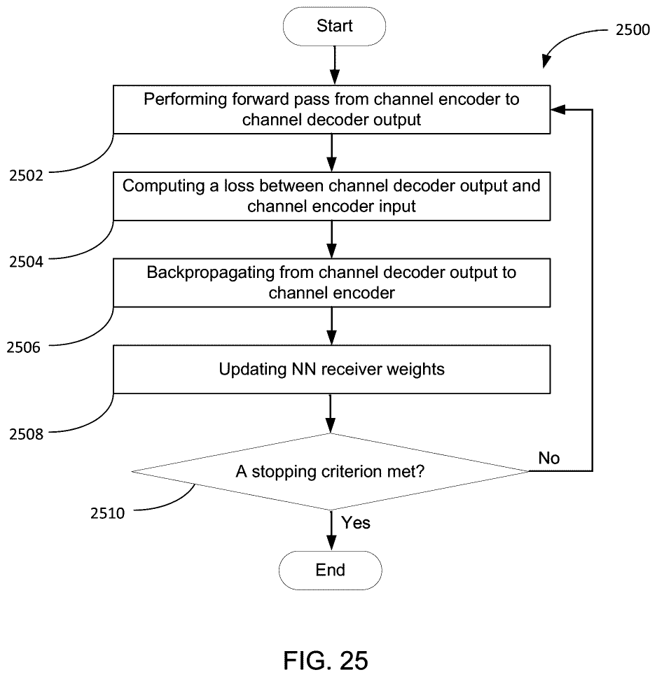

In this embodiment, the output of the NN Rx 2416 may include LLRs 2426 that can be passed to the channel decoder 2429. The output of the channel decoder 2429 may include estimated bits 2431 that may be passed to the loss function 2430. The loss function 2430 may compare the estimated bits 2431 with the bits 2401 that are input to the channel coder 2404, and the resulting error may be utilized to update the weights of the NN Rx 2416. The NN Rx training method is discussed further in detail with reference to FIG. 25.

FIG. 25 illustrates an example method 2500 for training an NN Rx for data-aided communications in accordance with example embodiments of the present disclosure. The method 2500 may be performed by any components (e.g., one or more processors 225, 340 or 415 of a BS 101-103, a UE 111-116 or a server 132 of FIGS. 1-4) of the data-aided communication system (e.g., the data-aided communication system 2411 of FIG. 24). The embodiment of the method illustrated in FIG. 25 is for illustration only. One or more of the components illustrated in FIG. 25 may be implemented in specialized circuitry configured to perform the noted functions or one or more of the components may be implemented by one or more processors executing instructions to perform the noted functions. Other embodiments of methods for training the NN Rx could be used without departing from the scope of this disclosure.

In the example shown in FIG. 25, the method 2500 begins at step 2502. At step 2502, a forward pass may be performed from the input of a channel encoder to the output of a channel decoder. This may include the processor 225 or 340 passing uncoded bits to the channel encoder for modulation, performing CP-OFDM transmission processing on the modulated symbols and transmitting the OFDM symbols in time-domain over a channel. This may also include the processor 225 or 340 receiving the modulated OFDM symbols via the channel, performing CP-OFDM reception processing, performing soft-demodulation to extract information about the input bits, decoding the information and inputting the estimated bits or soft decisions to a loss function. In some examples, the forward pass may refer to the series of the computational operations within the NN, e.g., initial convolution/activation, ResNet refinements, and soft demodulating (projecting soft decisions in, e.g., LLR space).

At step 2504, a loss between the channel decoder output and the channel encoder input may be calculated. This may include the processor 225, 340 or 415 comparing, using the loss function (e.g., mean squared error (MSE)), the estimated bits to target bits (the input bits to the channel encoder). The loss may be a scalar measuring prediction error across a batch.

At step 2506, a backward pass may be performed from the channel decoder output to the channel encoder input. This may include the processor 225, 340 or 415 determining the impact of each parameter (weight and bias) on the loss. For example, the processor 225, 340, or 415 may utilize the chain rule to compute partial derivatives of the loss corresponding to each parameter, working backward from the output (the estimated bits) to the input (the bits input to the channel encoder), across all NN Rx layers.

At step 2508, NN weights may be updated utilizing this backward pass. This may include the processor 225, 340 or 415 adjusting each parameter to reduce its impact or contribution to the loss. For example, the processor 225, 340 or 415 may change NN weights with an optimizer (e.g., Adam) so that CONV layers can better map noisy symbols to obtain accurate LLRs, thereby reducing the loss.

At step 2510, whether a stopping criterion is met may be determined. If yes, the method 2500 ends. If no, the method 2500 returns to step 2502 and steps 2502-2508 may be repeated until a stopping criterion is met. That is, the forward and backward passes with the loss computations and adjustments may be repeated until a stopping criterion is satisfied.

One example of a stopping criterion in step 2510 may be a testing loss decreasing below a threshold. One example of this threshold may be a configurable multiple of the nearest-neighbor distance in a modulation constellation. Another example of a stopping criterion may be a number of training epochs reaching a threshold. One example of this threshold may correspond to a time limit for online training.

In the method 2500, for one example, a batch size of one TTI can be configured. In another example, a batch size of one TTI can be configured in conjunction with multiple steps per training epoch, where each step entails processing one batch.

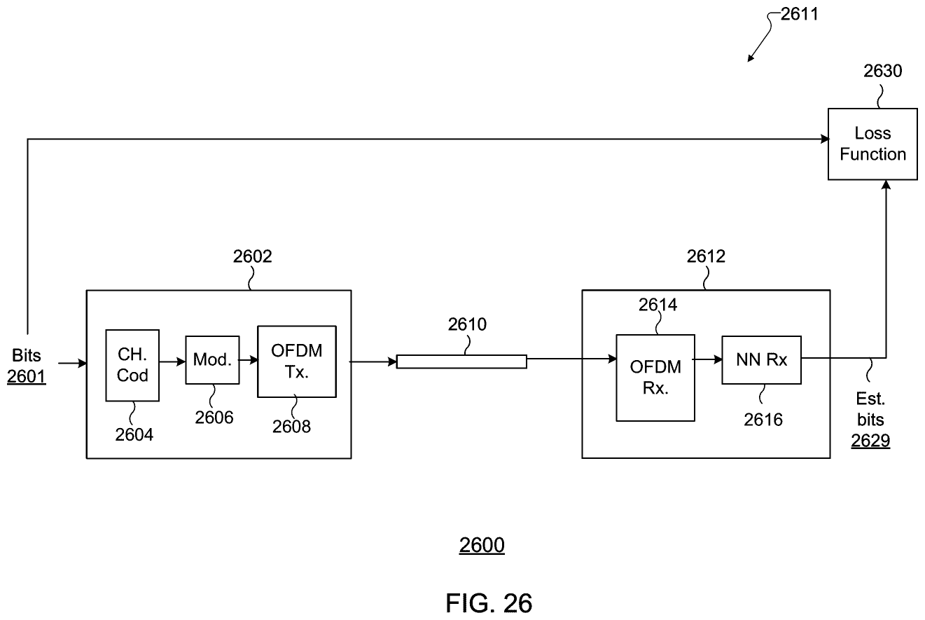

FIG. 26 illustrates an example pipeline 2600 for training an NN Rx with channel encoding for data-aided communications in accordance with example embodiments of the present disclosure. The embodiment of the example pipeline illustrated in FIG. 26 is for illustration only. One or more of the components illustrated in FIG. 26 may be implemented in specialized circuitry configured to perform the noted functions or one or more of the components may be implemented by one or more processors executing instructions to perform the noted functions. Other embodiments of example pipeline for training an NN Rx could be used without departing from the scope of this disclosure.

In the example shown in FIG. 26, the output of the NN Rx may include estimated bits 2629 that can be passed to a loss function 2630. The loss function 2630 may compare the estimated bits 2629 with the bits 2601 that are input to a channel coder 2604, and the resulting error may be utilized to update the weights of the NN Rx 2616. Thus, the NN Rx 2616 may effectively replace the channel decoder 718, 2429 of FIG. 7 or 24.

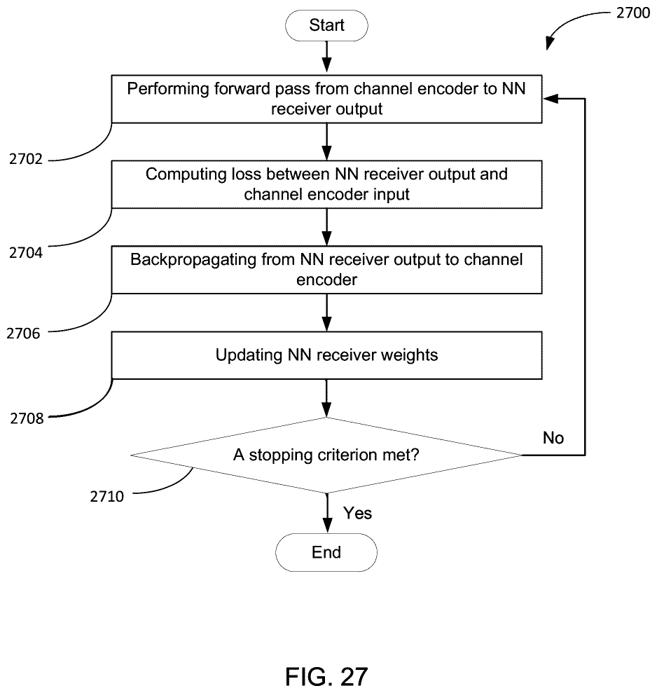

FIG. 27 illustrates an example method 2700 for training an NN Rx with channel encoding for data-aided communications in accordance with example embodiments of the present disclosure. The method 2700 may be performed by any components (e.g., one or more processors 225, 340 or 415 of a BS 101-103, a UE 111-116 or a server 132 of FIGS. 1-4) of the data-aided communication system (e.g., the data-aided communication system 2611 of FIG. 26). The embodiment of the method illustrated in FIG. 27 is for illustration only. One or more of the components illustrated in FIG. 27 may be implemented in specialized circuitry configured to perform the noted functions or one or more of the components may be implemented by one or more processors executing instructions to perform the noted functions. Other embodiments of methods for training the NN Rx could be used without departing from the scope of this disclosure.

In the example shown in FIG. 27, the method 2700 begins at step 2702. At step 2702, a forward pass from the input of a channel encoder block to the output of the NN Rx may be performed. At step 2704, the loss between the NN Rx output and the channel encoder input may be computed. At step 2706, a backward pass from the NN Rx output to the channel encoder input may be performed. At step 2708, NN Rx weights may be updated utilizing the backward pass.

At step 2710, whether a stopping criterion is met may be determined. If yes, the method 2700 ends. If not, the method 2700 returns to step 2702 and steps 2702-2708 may be repeated until a stopping criterion is met.

One example of a stopping criterion may be the testing loss decreasing below a threshold. One example of this threshold may be a configurable multiple of the nearest-neighbor distance in a modulation constellation. Another example of a stopping criterion may be the number of training epochs reaching a threshold. One example of this threshold may correspond to a time limit for online training.

In the method 2700, for one example, a batch size of one TTI can be configured. In another example, a batch size of one TTI can be configured in conjunction with multiple steps per training epoch, where each step entails processing one batch.

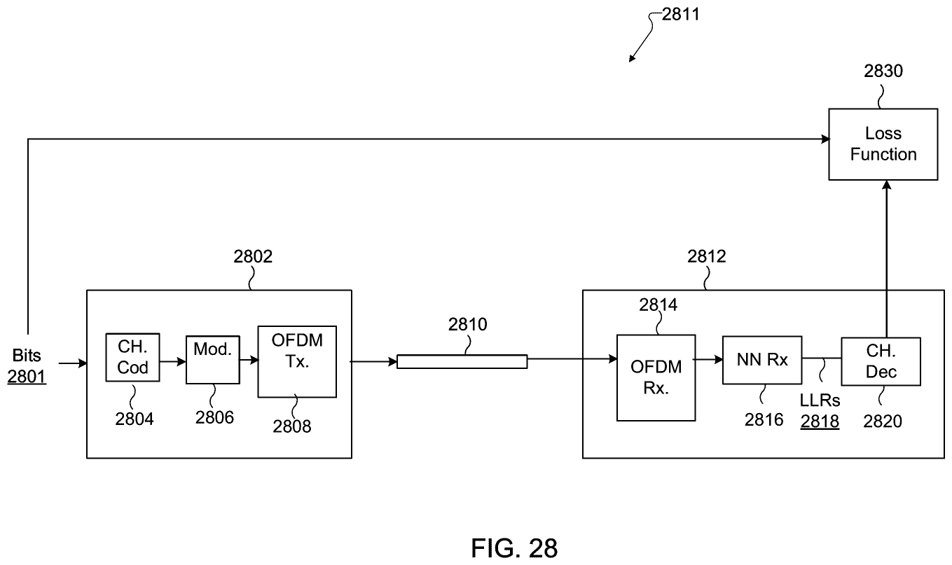

FIG. 28 illustrates an example pipeline 2800 for training an NN 2816 with other AI/ML blocks 2804, 2806, 2808, 2814 and 2820 in a data-aided communication system 2811 in accordance with example embodiments of the present disclosure. The embodiment of the example pipeline illustrated in FIG. 28 is for illustration only. One or more of the components illustrated in FIG. 28 may be implemented in specialized circuitry configured to perform the noted functions or one or more of the components may be implemented by one or more processors executing instructions to perform the noted functions. Other embodiments of example pipeline for training an NN Rx could be used without departing from the scope of this disclosure.

In the example shown in FIG. 28, a channel encoder 2804, a modulator 2806 and the CP-OFDM Tx 2808 of a Tx architecture 2802 may be AI-based. Further, a CP-OFDM Rx 2814 and a channel decoder 2820 of an Rx architecture 2812 may also be AI-based. Hence, the NN Rx and one or more of the other AI-based components 2804, 2806, 2808, 2814 and 2820 of the data-aided communication system 2811 may be trainable.

In one example, the NN Rx 2816 and one or more of the AI-based blocks 2804, 2806, 2808, 2814 and 2820 can be trained end-to-end. In another example, the NN Rx 2816 and one or more of the AI-based blocks 2804, 2806, 2808, 2814 and 2820 can be alternately trained, where the weights of one block are trained while the weights of all other blocks are fixed.

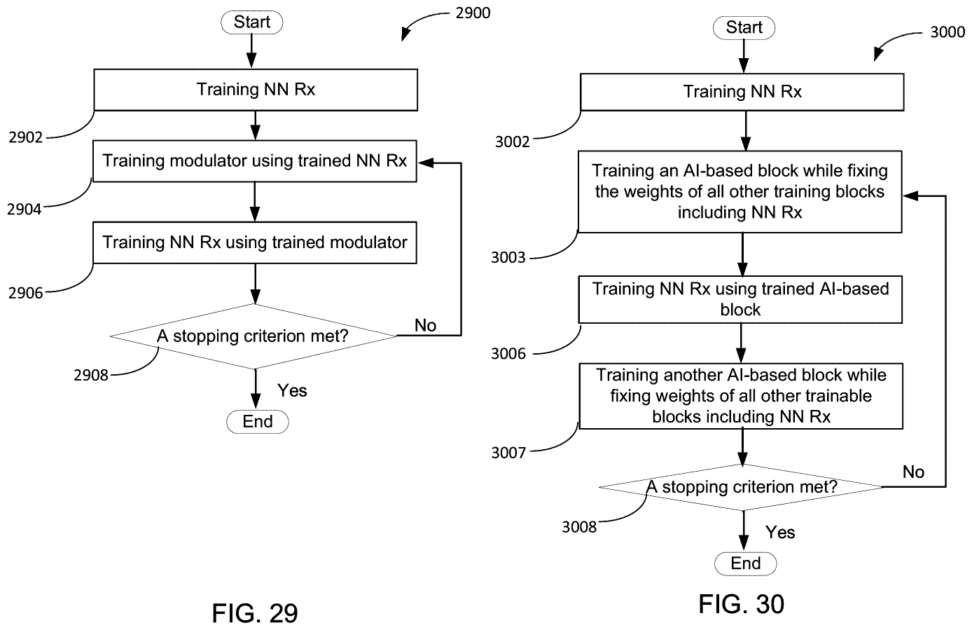

FIGS. 29 and 30 illustrate example methods 2900, 3000 for training an NN Rx with other AI-based components in a data-aided communication system in accordance with example embodiments of the present disclosure. The methods 2900, 3000 may be performed by any components (e.g., one or more processors 225, 340 or 415 of a BS 101-103, a UE 111-116 or a server 132 of FIGS. 1-4) of the data-aided communication system (e.g., the data-aided communication system 2811 of FIG. 28). The embodiments of the methods illustrated in FIGS. 29 and 30 are for illustration only. One or more of the components illustrated in FIGS. 29 and 30 may be implemented in specialized circuitry configured to perform the noted functions or one or more of the components may be implemented by one or more processors executing instructions to perform the noted functions. Other embodiments of methods for training the NN Rx could be used without departing from the scope of this disclosure.

In the example shown in FIG. 29, the method 2900 begins at step 2902. At step 2902, the NN Rx may be trained with a fixed NN modulator (e.g., the AI-based modulator 2806 of FIG. 28). At step 2904, the NN modulator may be trained with the trained NN Rx. At step 2906, the NN Rx may be trained with the trained NN modulator. At operation 2908, whether a stopping criterion is met may be determined. If yes, the method 2900 may end. If not, the method 2900 may return to step 2904 and steps 2904 and 2906 may be repeated until a stopping criterion is met.

One example of a stopping criterion may be the testing loss decreasing below a threshold. One example of this threshold may be a configurable multiple of the nearest-neighbor distance in a modulation constellation. Another example of a stopping criterion may be the number of training epochs reaching a threshold. One example of this threshold may correspond to a time limit for online training.

In one example, the modulator in steps 2904 and 2906 can be trained to produce a modulation constellation such as one of the modulation constellations in FIG. 6. In one example, the modulator can be replaced by channel encoder and/or decoder blocks. In this case, the RS density in the CP-OFDM Tx and/or CP-OFDM Rx blocks could depend on the trained channel coding rate. In another example, the modulator can be replaced by the CP-OFDM Tx and/or CP-OFDM Rx blocks, where the RS density could be fixed while the RS pattern itself could be trained.

In another example, one or more of the modulator, the channel encoder, the CP-OFDM Tx, the CP-OFDM Rx, and the channel decoder may be configured to be trainable. If at least two of these blocks are trainable, then between steps 2902 and 2904, an additional operation may be performed at 3003 as illustrated in FIG. 30. At step 3003, an AI-based block may be trained while fixing the weights of all other trainable blocks, including the NN Rx. Also, between steps 2906 and 2908, another additional operation may be performed at step 3007. At step 3007, another AI-based block may be trained while fixing the weights of all other trainable blocks, including the NN Rx

In the methods 2900, 3000, for example, a batch size of one TTI can be configured. In another example, a batch size of one TTI can be configured in conjunction with multiple steps per training epoch, where each step entails processing one batch.

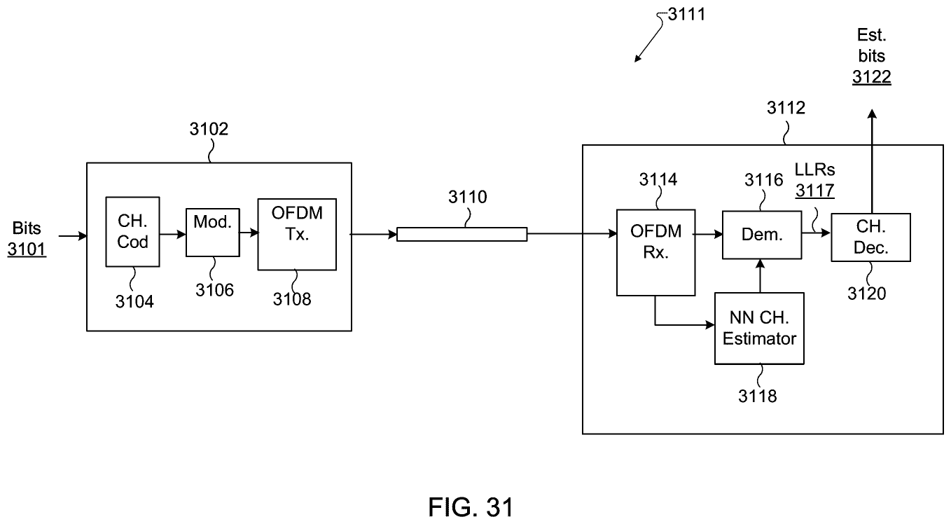

FIG. 31 illustrates an example architecture of an Rx architecture 3112 with an AI channel estimator 3118 in a data-aided communication system 3111 in accordance with example embodiments of the present disclosure. The Rx architecture 3112 may be similar to the Rx architecture 712, 1012, 2812 of FIG. 7, 10 or 28, but differs from the latter in that it includes a demodulator 3116 and an NN channel estimator 3118. The embodiment of the example architecture illustrated in FIG. 31 is for illustration only. One or more of the components illustrated in FIG. 31 may be implemented in specialized circuitry configured to perform the noted functions or one or more of the components may be implemented by one or more processors executing instructions to perform the noted functions. Other embodiments of the Rx architectures for a data-aided communication system could be used without departing from the scope of this disclosure.

As illustrated in FIG. 31, the Rx architecture 3112 may also include an NN channel estimator 3118 in addition to the demodulator 3116. In this case, the NN channel estimator may generate channel estimates that are passed as secondary inputs to the demodulator 3116, which utilizes those secondary inputs along with the outputs of the CP-OFDM Rx 3114 to generate LLRs 3117 that are passed to the channel decoder 3120.

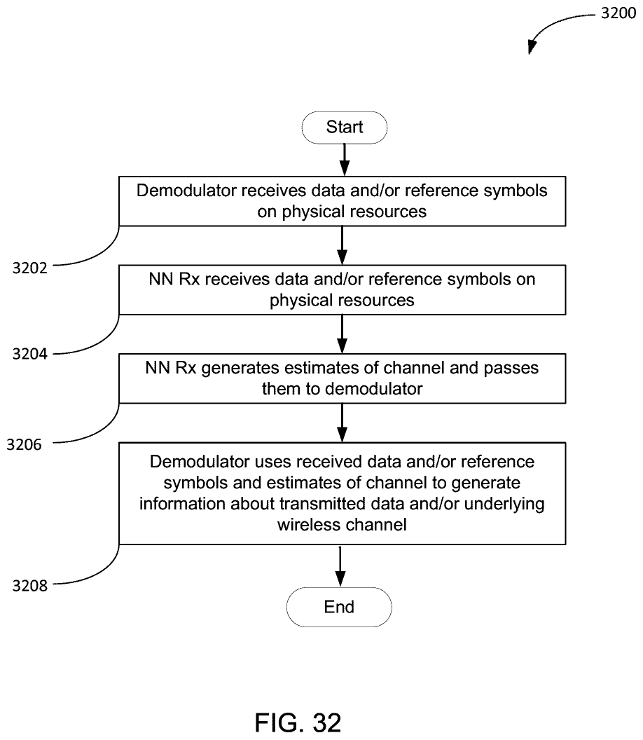

One example of the demodulator 3116 may be an NN Rx (e.g., the NN Rx 716, 1016, 2816 of FIG. 7, 10 or 28). Another example of the demodulator 3116 may be a regular (e.g., extant) receiver. The operations of the demodulator 3116 and the NN channel estimator 3118 are discussed in detail with reference to FIG. 32.

FIG. 32 illustrates an example method 3200 for operations at an Rx architecture for data-aided communication with an NN channel estimator in accordance with example embodiments of the present disclosure. The method 3200 may be performed by any components of the data-aided communication system (e.g., the data-aided communication system 3111 of FIG. 31). The embodiment of the method illustrated in FIG. 32 is for illustration only. One or more of the components illustrated in FIG. 32 may be implemented in specialized circuitry configured to perform the noted functions or one or more of the components may be implemented by one or more processors executing instructions to perform the noted functions. Other embodiments of methods for operations at Rx architecture for data-aided communications could be used without departing from the scope of this disclosure.

In the example shown in FIG. 32, the method 3200 begins at step 3202. At step 3202, a demodulator (e.g., the demodulator 3116 of FIG. 31) may receive data and/or RS on physical resources. One example of physical resources may include REs in a time-frequency grid that spans one TTI. At step 3204, the NN Rx (e.g., NN Rx 716, 1016 of FIG. 7 or 10) may receive data and/or RS on physical resources. One example of physical resources is REs in a time-frequency grid that spans one TTI.

At step 3206, the NN Rx may utilize the received data and/or RS to generate and pass channel estimates to the demodulator. At step 3208, the demodulator may utilize the generated channel estimates and the received data and/or RS to generate information about transmitted data and/or the underlying wireless channel (e.g., the channel 3110 of FIG. 31).

In one example, the demodulator can be an NN Rx. In another example, the demodulator can be a regular (e.g., extant) receiver.

In one example, the generated information at step 3208 can include LLRs (e.g., LLRs 3117 of FIG. 31) that can be passed to a channel decoder (e.g., a channel decoder 3120 of FIG. 31). In another example, the generated information can include soft-demodulated symbols. In another example, the generated information can include channel estimates. In another example, the generated information can include estimates (e.g., the estimated bits 3122 of FIG. 31) of the transmitted bits.

In one example, the demodulator and/or the NN Rx may include one or more layers that have been trained with a modulation constellation for data-aided communication and an error function.

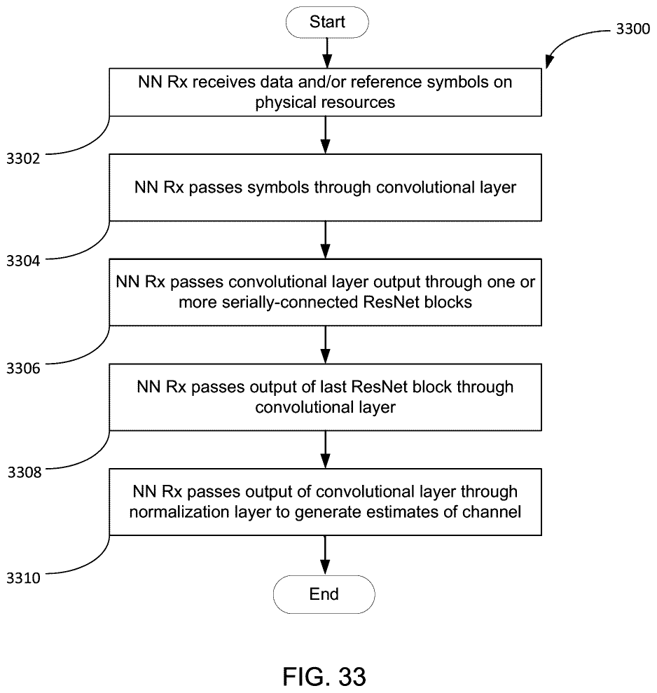

FIG. 33 illustrates an example method 3300 for operations at an Rx architecture for a data-aided communication system in accordance with example embodiments of the present disclosure. The method 3300 may be performed by any components of the data-aided communication system (e.g., the data-aided communication system 700, 1000 of FIG. 7 or 10). The embodiment of the method illustrated in FIG. 33 is for illustration only. One or more of the components illustrated in FIG. 33 may be implemented in specialized circuitry configured to perform the noted functions or one or more of the components may be implemented by one or more processors executing instructions to perform the noted functions. Other embodiments of methods for operations at Rx architecture for data-aided communications could be used without departing from the scope of this disclosure.

In the example shown in FIG. 33, the method 3300 begins at step 3302. At step 3302, an NN Rx may receive data and/or RS on physical resources. One example of physical resources may be REs in a time-frequency grid that spans one TTI. At step 3304, the NN Rx may pass received symbols through a CONV layer.

At step 3306, the NN Rx may pass the output of the CONV layer through one or more serially-connected ResNet blocks. At step 3308, the NN RX may pass the output of the last ResNet block through a CONV layer.

In one example, at step 3308, the number of output channels in the CONV layer can be set to “2” to correspond to the {magnitude, phase} or {real part, imaginary part} for the generated complex-valued channel estimates.

At step 3310, the NN Rx may pass the output of the CONV layer through a normalization layer to generate channel estimates. This normalization layer can be configured based on the knowledge of channel statistical information.

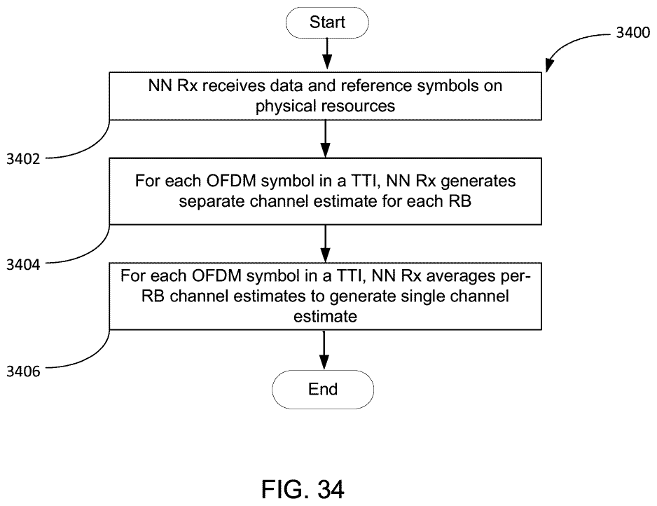

FIG. 34 illustrates an example method 3400 for operations at an Rx architecture with per-RB processing for an NN channel estimator in accordance with example embodiments of the present disclosure. The method 3400 may be performed by any components of a data-aided communication system (e.g., the data-aided communication system 3111 of FIG. 31). The embodiment of the method illustrated in FIG. 34 is for illustration only. One or more of the components illustrated in FIG. 34 may be implemented in specialized circuitry configured to perform the noted functions or one or more of the components may be implemented by one or more processors executing instructions to perform the noted functions. Other embodiments of methods for operations at Rx architecture for data-aided communications could be used without departing from the scope of this disclosure.

In the example shown in FIG. 34, the method 3400 begins at step 3402. At step 3402, an NN Rx may receive data and RS on physical resources. One example of physical resources may be REs in a time-frequency grid that spans one TTI.

At step 3404, for each OFDM symbol in a TTI, the NN Rx may generate a channel estimate for each RB. At step 3406, for each OFDM symbol in a TTI, the NN Rx may average the per-RB channel estimates to generate a single channel estimate.

In one example, at step 3406, the NN Rx can perform an interpolation across the per-RB channel estimates to generate channel estimates for an entire time-frequency grid that spans one TTI.

Table 2 below shows an example architecture for an NN channel estimator. The number of ResNet blocks may be set to five, with each ResNet block including two serially-connected sub-blocks of the form (BN+CONV+ELU) and (BN+CONV+add+ELU).

TABLE 2
Example NN Channel Estimator Architecture
for Data-aided Communication

| | Output |
|---|---|
| Layers | Dimensions |
| Input | 2 × 120 × 14 |
| CONV + ELU | 128 × 120 × 14 |
| Five of {(BN + CONV + ELU) + | 128 × 120 × 14 |
| (BN + CONV + add + ELU)} | |
| BN + CONV | 6 × 120 × 14 |

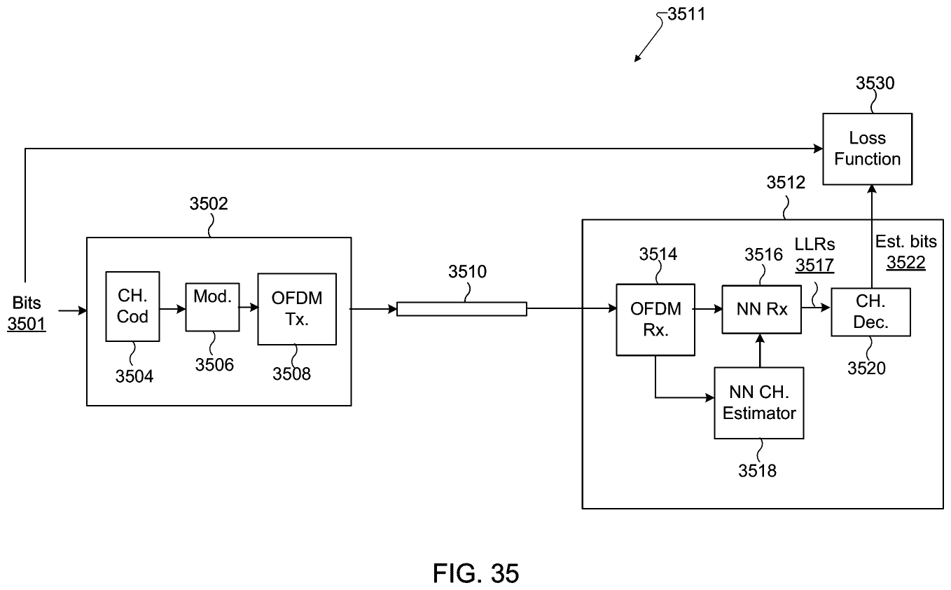

FIG. 35 illustrates an example pipeline 3500 of training an NN Rx with an NN channel estimator in a data-aided communication system 3511 in accordance with example embodiments of the present disclosure. The embodiment of the example pipeline illustrated in FIG. 35 is for illustration only. One or more of the components illustrated in FIG. 35 may be implemented in specialized circuitry configured to perform the noted functions or one or more of the components may be implemented by one or more processors executing instructions to perform the noted functions. Other embodiments of example pipeline for training an NN Rx and an NN channel estimator could be used without departing from the scope of this disclosure.

In the example shown in FIG. 35, the output of the NN Rx may include the output of LLRs 3517 that are passed to a channel decoder 3520. The output of the channel decoder 3520 may include estimated bits 3522 that may be passed to a loss function 3530. The loss function 3530 may compare the estimated bits 3522 with the bits 3501 that are input to the channel coder 3504, and the resulting error may be utilized to update the weights of the NN Rx 3516 and NN channel estimator 3518.

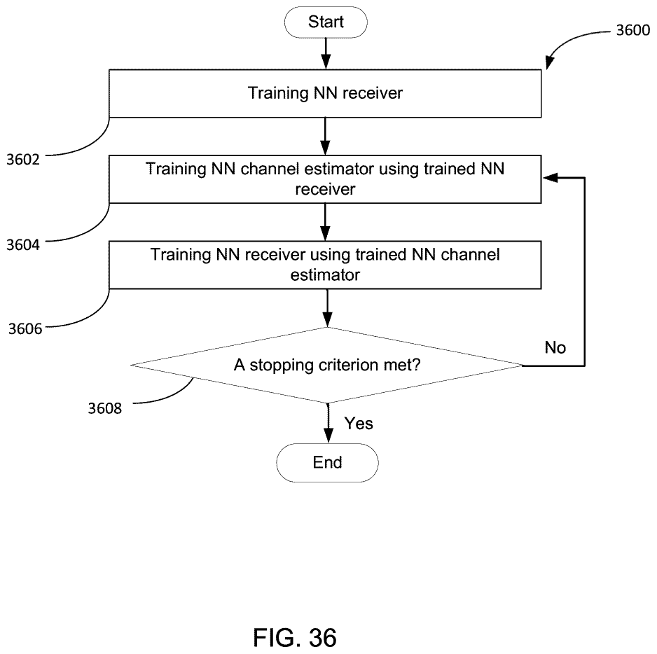

FIG. 36 illustrates an example method 3600 for training an NN Rx and an NN channel estimator in a data-aided communication system in accordance with example embodiments of the present disclosure. The method 3600 may be performed by any components (e.g., one or more processors 225, 340 or 415 of a BS 101-103, a UE 111-116 or a server 132 of FIGS. 1-4) of the data-aided communication system (e.g., the data-aided communication system 3511 of FIG. 35). The embodiment of the method illustrated in FIG. 36 are for illustration only. One or more of the components illustrated in FIG. 36 may be implemented in specialized circuitry configured to perform the noted functions or one or more of the components may be implemented by one or more processors executing instructions to perform the noted functions. Other embodiments of methods for training the NN Rx and NN channel estimator could be used without departing from the scope of this disclosure.

In the example shown in FIG. 36, the method 3600 begins at step 3602. At step 3602, an NN Rx may be trained with a fixed NN channel estimator. At step 3604, the NN channel estimator may be trained with the trained NN Rx. At step 3606, the NN Rx may be trained with the trained NN channel estimator.

At step 3608, whether a stopping criterion is met may be determined. If yes, the method 3600 ends. If not, the method 3600 returns to step 3604 and steps 3604 and 3606 may be repeated until a stopping criterion is met.

One example of a stopping criterion may be the testing loss decreasing below a threshold. One example of this threshold may be a configurable multiple of the nearest-neighbor distance in a modulation constellation. Another example of a stopping criterion may be the number of training epochs reaching a threshold. One example of this threshold may correspond to a time limit for online training.

In the method 3600, in one example, a batch size of one TTI can be configured. In another example, a batch size of one TTI can be configured in conjunction with multiple steps per training epoch, where each step entails processing one batch.

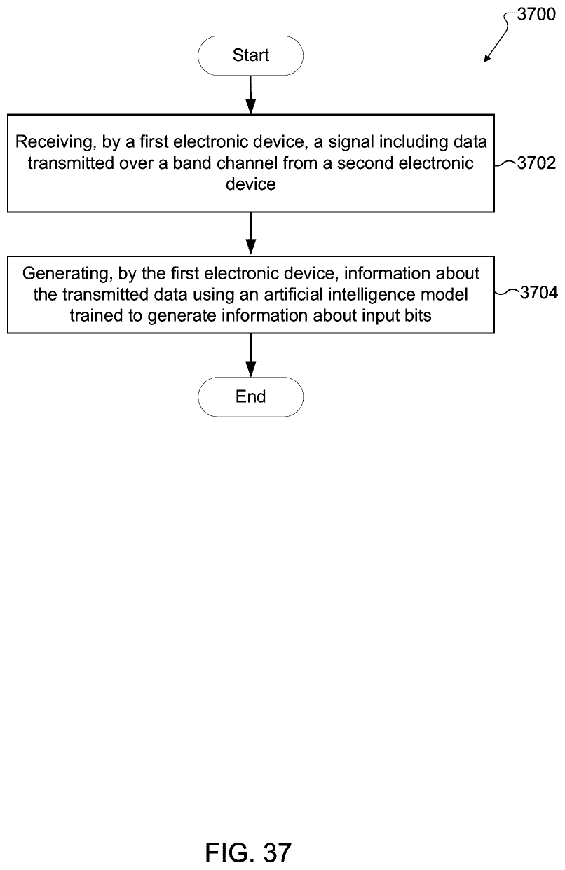

FIG. 37 illustrates an example flow chart for a method 3700 of generating information associated with transmitted data using an NN Rx in accordance with example embodiments of the present disclosure. The method 3700 may be performed by a data-aided communication system (e.g., the data-aided communication system 700, 1000 of FIG. 7 or 10) and any components thereof. An embodiment of the method illustrated in FIG. 37 is for illustration only. One or more of the components illustrated in FIG. 37 may be implemented in specialized circuitry configured to perform the noted functions or one or more of the components may be implemented by one or more processors executing instructions to perform the noted functions. Other embodiments of generating information associated with transmitted data using an NN Rx could be utilized without departing from the scope of this disclosure.

As illustrated in FIG. 37, the method 3700 begins at step 3702. At step 3702, a first electronic device (e.g., a gNB 101-103 or a UE 111-116 of FIGS. 1, 2 and/or 3) may receive a signal transmitted over a band channel from a second electronic device (e.g., a gNB 101-103 or a

UE 111-116 of FIGS. 1, 2 and/or 3). The first electronic device and/or the second electronic device may be AI-based.

At step 3704, the first electronic device may generate information about the transmitted data using an AI model trained to generate information about input bits. The AI model may be, e.g., the NN Rx 716, 1016 of FIG. 7 or 10.

In one embodiment, the information about the transmitted data may be generated by inputting the received signal including one or more symbols to an initial convolutional layer of the AI model to extract feature maps associated with the one or more symbols, passing the feature maps through one or more serially-connected ResNet to generate an output including refined feature maps, and feeding the output from a last ResNet of the one or more serially-connected ResNet to a final convolutional layer to generate the information about the transmitted data.

In one embodiment, the information about the transmitted data may be generated by inputting the received signal including one or more symbols to an initial convolutional layer of the AI model to extract linear feature maps associated with the one or more symbols; passing the linear feature maps to an initial activation function of the AI model to generate nonlinear feature maps;

passing the nonlinear feature maps through one or more serially-connected ResNet of the AI model to generate an output including refined feature maps, and feeding the output from a last ResNet of the one or more serially-connected ResNet to a final batch normalization layer and a final convolutional layer of the AI model to generate the information about the transmitted data, the final convolutional layer immediately following the final batch normalization layer. Each ResNet may include a first subblock including a first batch normalization layer, a first convolutional layer and a first activation function, a second subblock including a second batch normalization layer and a second convolutional layer, a residual addition function, and a second activation function immediately following the residual addition function.

In one embodiment, the signal may further include one or more RSs and the information about the transmitted data may be generated by inputting, to the AI model, the transmitted data over one or more data channels and the one or more RSs over one or more RS channels; estimating, using one of the AI model or a separate AI channel estimation model, channels for corresponding resource blocks (RBs) based on the one or more RSs; and generating, using the AI model, the information about the transmitted data based on the estimated channels.

In one embodiment, the first electronic device may further generate, using the AI model, at least one of signal to noise ratio estimates, channel estimates, delay spread estimates, Doppler shift estimates, and channel model classification; and configure at least one of the AI model and weights of the AI model.

In one embodiment, the first electronic device may further iteratively pass the generated information to the AI model to generate updated information about the transmitted data until a predefined stopping criterion is satisfied.

In one embodiment, the AI model may be trained. This may include a corresponding processor of a data-aided transmission system passing a model output of the AI model to a loss function. The data-aided transmission system may include the first electronic device and the second electronic device. It may also include other electronic devices (e.g., a network server 132 of FIGS. 1 and 4) as appropriate without departing from the scope of this disclosure. The corresponding processor may compute a loss between the model output and the input bits using the loss function and update weights of the AI model.

In one embodiment, the AI model may be trained further by the corresponding processor of the data-aided transmission system including the first electronic device and the second electronic device. This may include the corresponding processor performing a forward pass from a channel encoder input to a channel decoder output and computing a loss between the channel encoder input and the channel decoder output using a loss function. This may also include the corresponding processor backpropagating from the channel decoder output to the channel encoder input and updating weights of the AI model based on the loss until a stopping criterion is satisfied.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method comprising:
receiving, by a first electronic device, a signal including data transmitted over a band channel from a second electronic device; and
generating, by the first electronic device, information about the transmitted data using an artificial intelligence (AI) model trained to generate information about input bits.

2. The method of claim 1, wherein generating the information about the transmitted data comprises:
inputting the received signal including one or more symbols to an initial convolutional layer of the AI model to extract feature maps associated with the one or more symbols;
passing the feature maps through one or more serially-connected residual networks (ResNet) to generate an output including refined feature maps; and
feeding the output from a last ResNet of the one or more serially-connected ResNet to a final convolutional layer to generate the information about the transmitted data.

3. The method of claim 1, wherein generating the information about the transmitted data comprises:
inputting the received signal including one or more symbols to an initial convolutional layer of the AI model to extract linear feature maps associated with the one or more symbols;
passing the linear feature maps to an initial activation function of the AI model to generate nonlinear feature maps;
passing the nonlinear feature maps through one or more serially-connected residual networks (ResNet) of the AI model to generate an output including refined feature maps, each ResNet comprising a first subblock including a first batch normalization layer, a first convolutional layer and a first activation function, a second subblock including a second batch normalization layer and a second convolutional layer, a residual addition function, and a second activation function immediately following the residual addition function; and
feeding the output from a last ResNet of the one or more serially-connected ResNet to a final batch normalization layer and a final convolutional layer of the AI model to generate the information about the transmitted data, the final convolutional layer immediately following the final batch normalization layer.

4. The method of claim 1, wherein:
the signal further includes one or more reference signals (RSs); and
generating the information about the transmitted data comprises:
inputting, to the AI model, the transmitted data over one or more data channels and the one or more RSs over one or more RS channels;
estimating, using one of the AI model or a separate AI channel estimation model, channels for corresponding resource blocks (RBs) based on the one or more RSs; and
generating, using the AI model, the information about the transmitted data based on the estimated channels.

5. The method of claim 1, further comprising:
generating, by the first electronic device, at least one of signal to noise ratio estimates, channel estimates, delay spread estimates, Doppler shift estimates, and channel model classification using the AI model; and
configuring, by the first electronic device, at least one of the AI model and weights of the AI model.

6. The method of claim 1, further comprising:
iteratively passing, by the first electronic device, the generated information to the AI model to generate updated information about the transmitted data until a predefined stopping criterion is satisfied.

7. The method of claim 1, wherein the AI model is trained by:
passing, by a corresponding processor of a data-aided transmission system including the first electronic device and the second electronic device, a model output of the AI model to a loss function;
computing, by the corresponding processor, a loss between the model output and the input bits; and
updating, by the corresponding processor, weights of the AI model.

8. The method of claim 1, wherein the AI model is trained by:
performing, by a corresponding processor of a data-aided transmission system including the first electronic device and the second electronic device, a forward pass from a channel encoder input to a channel decoder output;
computing, by the corresponding processor, a loss between the channel encoder input and the channel decoder output using a loss function;
backpropagating, by the corresponding processor, from the channel decoder output to the channel encoder input; and
updating, by the corresponding processor, weights of the AI model based on the loss until a stopping criterion is satisfied.

9. A first electronic device comprising:
a memory;
a processor operably coupled to the memory, the processor configured to:
receive, from a second electronic device, a signal including data transmitted over a band channel; and
generate information about the transmitted data using an artificial intelligence (AI) model trained to generate information about input bits.

10. The first electronic device of claim 9, wherein to generate the information about the transmitted data, the processor is further configured to:
input the received signal including one or more symbols to an initial convolutional layer of the AI model to extract feature maps associated with the one or more symbols;
pass the feature maps through one or more serially-connected residual networks (ResNet) to generate an output including refined feature maps; and
feed the output from a last ResNet of the one or more serially-connected ResNet to a final convolutional layer to generate the information about the transmitted data.

11. The first electronic device of claim 9, wherein to generate the information about the transmitted data, the processor is further configured to:
input the received signal including one or more symbols to an initial convolutional layer of the AI model to extract linear feature maps associated with the one or more symbols;
pass the linear feature maps to an initial activation function of the AI model to generate nonlinear feature maps;
pass the nonlinear feature maps through one or more serially-connected residual networks (ResNet) of the AI model to generate an output including refined feature maps, each ResNet comprising a first subblock including a first batch normalization layer, a first convolutional layer and a first activation function, a second subblock including a second batch normalization layer and a second convolutional layer, a residual addition function, and a second activation function immediately following the residual addition function; and
feed the output from a last ResNet of the one or more serially-connected ResNet to a final batch normalization layer and a final convolutional layer of the AI model to generate the information about the transmitted data, the final convolutional layer immediately following the final batch normalization layer.

12. The first electronic device of claim 9, wherein:
the signal further includes one or more reference signals (RSs); and
to generate the information about the transmitted data, the processor is further configured to:
input, to the AI model, the transmitted data over one or more data channels and the one or more RSs over one or more RS channels;
estimate, using one of the AI model or a separate AI channel estimation model, channels for corresponding resource blocks (RBs) based on the one or more RSs; and
generate, using the AI model, the information about the transmitted data based on the estimated channels.

13. The first electronic device of claim 9, wherein the processor is further configured to:
generate at least one of signal to noise ratio estimates, channel estimates, delay spread estimates, Doppler shift estimates, and channel model classification using the AI model; and
configure at least one of the AI model and weights of the AI model.

14. The first electronic device of claim 9, wherein the processor is further configured to:
iteratively pass the generated information to the AI model to generate updated information about the transmitted data until a predefined stopping criterion is satisfied.

15. The first electronic device of claim 9, wherein the AI model is trained by:
passing, by a corresponding processor of a data-aided transmission system including the first electronic device and the second electronic device, a model output of the AI model to a loss function;
computing, by the corresponding processor, a loss between the model output and the input bits; and
updating, by the corresponding processor, weights of the AI model.

16. The first electronic device of claim 9, wherein the AI model is trained by:
performing, by a corresponding processor of a data-aided transmission system including the first electronic device and the second electronic device, a forward pass from a channel encoder input to a channel decoder output;
computing, by the corresponding processor, a loss between the channel encoder input and the channel decoder output using a loss function;
backpropagating, by the corresponding processor, from the channel decoder output to the channel encoder input; and
updating, by the corresponding processor, weights of the AI model based on the loss until a stopping criterion is satisfied.

17. A non-transitory computer readable medium embodying a computer program, the computer program comprising program code that, when executed by a processor of a first electronic device, causes the first electronic device to:
receive, from a second electronic device, a signal including data transmitted over a band channel; and
generate information about the transmitted data using an artificial intelligence (AI) model trained to generate information about input bits.

18. The non-transitory computer readable medium of claim 17, wherein the program code that, when executed by the processor of the first electronic device, causes the first electronic device to generate the information about the transmitted data comprises program code that, when executed by the processor of the first electronic device, causes the first electronic device to:
input the received signal including one or more symbols to an initial convolutional layer of the AI model to extract feature maps associated with the one or more symbols;
pass the feature maps through one or more serially-connected residual networks (ResNet) to generate an output including refined feature maps; and
feed the output from a last ResNet of the one or more serially-connected ResNet to a final convolutional layer to generate the information about the transmitted data.

19. The non-transitory computer readable medium of claim 17, wherein the program code that, when executed by the processor of the first electronic device, causes the first electronic device to generate the information about the transmitted data comprises program code that, when executed by the processor of the first electronic device, causes the first electronic device to:
input the received signal including one or more symbols to an initial convolutional layer of the AI model to extract linear feature maps associated with the one or more symbols;
pass the linear feature maps to an initial activation function of the AI model to generate nonlinear feature maps;
pass the nonlinear feature maps through one or more serially-connected residual networks (ResNet) of the AI model to generate an output including refined feature maps, each ResNet comprising a first subblock including a first batch normalization layer, a first convolutional layer and a first activation function, a second subblock including a second batch normalization layer and a second convolutional layer, a residual addition function, and a second activation function immediately following the residual addition function; and
feed the output from a last ResNet of the one or more serially-connected ResNet to a final batch normalization layer and a final convolutional layer of the AI model to generate the information about the transmitted data, the final convolutional layer immediately following the final batch normalization layer.

20. The non-transitory computer readable medium of claim 17, wherein:
the signal further includes one or more reference signals (RSs); and
the program code that, when executed by the processor of the first electronic device, causes the first electronic device to generate the information about the transmitted data comprises program code that, when executed by the processor of the first electronic device, causes the first electronic device to:
input, to the AI model, the transmitted data over one or more data channels and the one or more RSs over one or more RS channels;
estimate, using one of the AI model or a separate AI channel estimation model, channels for corresponding resource blocks (RBs) based on the one or more RSs; and
generate, using the AI model, the information about the transmitted data based on the estimated channels.
